(19) United States
(12) Patent Application Publication
(10) Pub. No.: US 2017/0330251 A1
(43) Pub. Date: Nov. 16, 2017

(54) COLLABORATION

(71) Applicants: Phillip George Ammar, Cleveland Heights, OH (US); Ronald Charles Krosky, Columbia, MD (US); Brendan Edward Clark, Rocky River, OH (US)

(72) Inventors: Phillip George Ammar, Cleveland Heights, OH (US); Ronald Charles Krosky, Columbia, MD (US); Brendan Edward Clark, Rocky River, OH (US)

(21) Appl. No.: 13/037,400

(22) Filed: Mar. 1, 2011

Related U.S. Application Data
(60) Provisional application No. 61/311,016, filed on Mar. 5, 2010.

(51) Int. Cl. G06Q 30/02

(52) U.S. Cl. CPC G06Q 30/0282

(57) ABSTRACT

Systems, methods, and other embodiments associated with collaboration are described. One example method comprises identifying a collaborative response situation. The method also comprises causing a collaborative response situation answer form to be disclosed, where the collaborative response situation answer form facilitates determining an answer for the collaborative response situation.

### CROSS REFERENCE TO RELATED APPLICATIONS

This application claims the benefit of U.S. provisional application Ser. No. 61/311,016 filed on Mar. 5, 2010, which is hereby wholly incorporated by reference.

### BACKGROUND

In a business environment, decisions can be made through a rigid business structure. For example, a company can be owned by shareholders that can elect a board of directors. The board of directors can hire high level executives, such as a Chief Operating Officer, Chief Executive Officer, Chief Financial Officer, and others. These high level executives can make major decisions for the company. In addition, high level executives can hire Vice Presidents and other high level company figures, such as Head Legal Counsel, Vice President of Intellectual Property, Vice President of Sale, and others. Various levels below Vice Presidents can be hired and individuals at these levels can make various decisions. For example, a human resources manager can decide if a secretary is hired, a production manager can decide when a piece of equipment is serviced, and others. Thus, individuals of the company can make business decisions.

### BRIEF DESCRIPTION OF THE FIGURES

The accompanying drawings, which are incorporated in and constitute a part of the detailed description, illustrate various example systems, methods, and other example embodiments of various innovative aspects. These drawings include:

FIG. 1 illustrates one embodiment of a system that includes a collection component and a selection component;

FIG. 2 illustrates one embodiment of a system that includes an aggregation component;

FIG. 3 illustrates one embodiment of a system that includes a weight component;

FIG. 4 illustrates one embodiment of an environment of how a decision can be made;

FIG. 5 illustrates one embodiment of an environment of how a decision can be made with weights;

FIG. 6 illustrates one embodiment of an interface;

FIG. 7 illustrates one embodiment of a system with an analysis component and a security component;

FIG. 8 illustrates one embodiment of a system with an implementation component;

FIG. 9 illustrates one embodiment of a system with an evaluation component, an amount component, and a compensation component;

FIG. 10 illustrates one embodiment of a system with a check component;

FIG. 11 illustrates one embodiment of a system with a monitor component, a determination component, and an update component;

FIG. 12 illustrates one embodiment of a system with a question set identification component, an answer form generation component, an answer form distribution component, a response set collection component, a course of actions election component, and a course of action implementation component;

FIG. 13 illustrates one embodiment of a system with a collaborative business decision identification component and a question set selection component;

FIG. 14 illustrates one embodiment of an environment where a bidding structure can be used;

FIG. 15 illustrates one embodiment of a decision tree for a question set;

FIG. 16 illustrates one embodiment of a method for collaborative situation responding;

FIG. 17 illustrates one embodiment of a method for proactively creating a collaborative response situation answer form;

FIG. 18 illustrates one embodiment of a method for evaluating a collaborative response situation answer form history;

FIG. 19 illustrates one embodiment of a method for making an answer determination;

FIG. 20 illustrates one embodiment of a method for causing at least one aspect to be included in a collaborative response situation form;

FIG. 21 illustrates one embodiment of a method for updating a database;

FIG. 22 illustrates one embodiment of a method for evaluating a person that submits a question;

FIG. 23 illustrates one embodiment of a method for determining a source for answering a question;

FIG. 24 illustrates one embodiment of method for analyzing a response;

FIG. 25 illustrates one embodiment of a system that may be used in practicing at least one aspect disclosed herein;

FIG. 26 illustrates one embodiment of a system, upon which at least one aspect disclosed herein can be practiced.

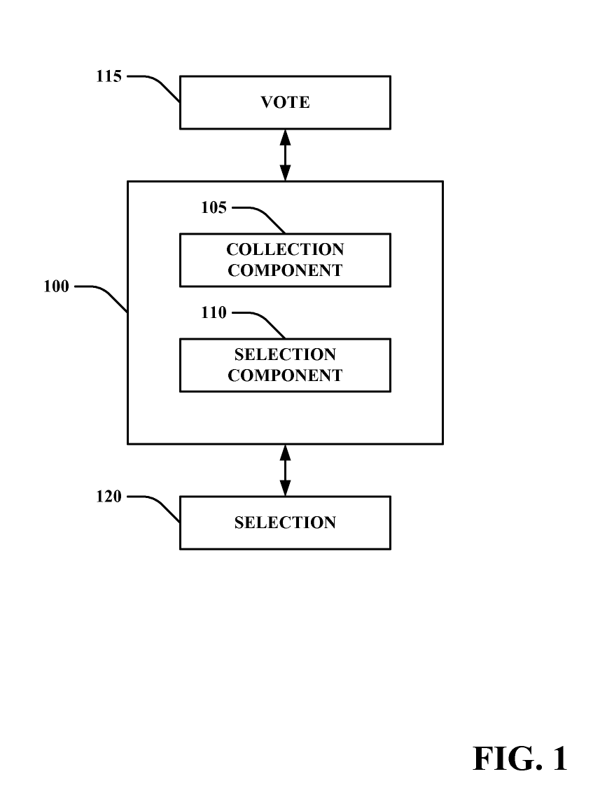

It will be appreciated that illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale. These elements and other variations are considered to be embraced by the general theme of the figures, and it is understood that the drawings are intended to convey the spirit of certain features related to this application, and are by no means regarded as exhaustive or fully inclusive in their representations. Additionally, it is to be appreciated that the designation ‘FIG.’ represents ‘Figure’. In one example, ‘FIG. 1’ and ‘FIG. 1’ are referring to the same drawing.

The terms ‘may’ and ‘can’ are used to indicate a permitted feature, or alternative embodiments, depending on the context of the description of the feature or embodiments. In one example, a sentence states ‘A can be AA’ or ‘A may be AA’. Thus, in the former case, in one embodiment A is AA, and in another embodiment A is not AA. In the latter case, A may be selected to be AA, or A may be selected not to be AA. However, this is an example of A, and A should not be construed as only being AA. In either case, however, the alternative or permitted embodiments in the written description are not to be construed as injecting ambiguity into the appended claims. Where claim ‘x’ recites A is AA, for instance, then A is not to be construed as being other than AA for purposes of claim x. This is construction is so despite any permitted or alternative features and embodiments described in the written description.

### DETAILED DESCRIPTION

Described herein are example systems, methods, and other embodiments associated with collaboration. Instead of business decisions being made by a single person or a small group, a community can make a business decision in a collaborative manner. For example, a restaurant can post a website where individuals can vote on a business decision on what menu items the restaurant should carry. These individuals can be frequent customers, previous customers, not be restricted, and others. Based on a collective response from these individuals, the restaurant can proactively place orders with vendors and/or distributors such that the menu items are obtained by the restaurant.

In addition to businesses, such as the restaurant, using collaborative functionality, collaborative functionality can be used by an individual. For example, a person can be at an airport and their flight can be delayed. During the delay, the person can send a message out asking for a suggestion on where to eat. Other airport patrons can provide recommendations on where the person should eat. These recommendations can be grouped together and used to suggest a restaurant to the person.

While these provide particular aspects of at least one embodiment, other applications involving different features, variations or combinations of aspects will be apparent to those skilled in the art based on the following details relating to the drawings and other portions of this application. Additionally, when a reference is made herein to a person, it is to be appreciated that the reference can be made to an organism or system.

The following paragraphs include definitions of selected terms discussed at least in the detailed description. The definitions may include examples used to explain features of terms and are not intended to be limiting. In addition, where a singular term is disclosed, it is to be appreciated that plural terms are also covered by the definitions. Conversely, where a plural term is disclosed, it is to be appreciated that a singular term is also covered by the definition. In addition, a set can include one or more member(s).

References to “one embodiment”, “an embodiment”, “one example”, “an example”, and so on, indicate that the embodiment(s) or example(s) so described may include a particular feature. The embodiment(s) or example(s) are shown to highlight one feature and no inference should be drawn that every embodiment necessarily includes that feature. Multiple usages of the phrase “in one embodiment” and others do not necessarily refer to the same embodiment; however this term may refer to the same embodiment. It is to be appreciated that multiple examples and/or embodiments may be combined together to form another embodiment.

“Computer-readable medium”, as used herein, refers to a medium that stores signals, instructions, and/or data. A computer may access a computer-readable medium and read information stored on the computer-readable medium. In one embodiment, the computer-readable medium stores instruction and the computer can perform those instructions as a method. The computer-readable medium may take forms, including, but not limited to, non-volatile media (e.g., optical disks, magnetic disks, and so on), and volatile media (e.g., semiconductor memories, dynamic memory, and so on). Example forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, and other media from which a computer, a processor or other electronic device can read.

“Component”, “logic”, “module”, “interface” and the like as used herein, includes but is not limited to hardware, firmware, software stored or in execution on a machine, a routine, a data structure, and/or at least one combination of these (e.g., hardware and software stored). Component, logic, module, and interface may be used interchangeably. A component may be used to perform a function(s) or an action(s), and/or to cause a function or action from another component, method, and/or system. A component may include a software controlled microprocessor, a discrete logic (e.g., ASIC), an analog circuit, a digital circuit, a programmed logic device, a memory device containing instructions, a process running on a processor, a processor, an object, an executable, a thread of execution, a program, a computer and so on. A component may include one or more gates, combinations of gates, or other circuit components. Where multiple components are described, it may be possible to incorporate the multiple components into one physical component. Similarly, where a single component is described, it may be possible to distribute that single component between multiple physical components. In one embodiment, the multiple physical components are distributed among a network. By way of illustration, both/either a controller and/or an application running on a controller can be one or more components.

FIG. 1 illustrates one embodiment of a system 100 that includes a collection component 105 and a selection component 110. The collection component 105 can be configured to obtain a vote 115 for a choice on a collaborative decision. A collaborative decision can be presented by an entity. In one example, the entity can be a business and the collaborative decision can be what products the business should carry in-store. A text message can be sent to registered members asking the registered users to vote on what products the business should carry in-store. The registered members can submit a user vote and the votes 115 can be the user vote and/or be an accumulation of user votes.

In one embodiment, in order to partake in the collaborative decision, a person can be required to be part of a community. Being part of the community can make the person a registered member, registered user, and others. To be part of the community, the person can be asked to register, pay a fee, and others.

The selection component 110 can be configured to proactively make a selection 120 for the collaborative decision based, at least in part, on the vote 115 for the choice. For example, the selection component 110 can analyze the vote 115 and determine what selection to make. In one example, a choice outcome with a highest number of votes can be selected. For example, a choice can be a couple can asking guests if the couple should serve chicken or fish at their wedding. If a highest number of guests selected fish, then fish can be proactively (e.g., automatically) selected. In one example, votes can be in response to an open-ended choice. For example, the couple can ask guests what they would like to eat. 50 guests can respond with ‘beef’, 40 guests can respond with ‘chicken’ and 15 guests can respond with ‘pork’. Due to white meats ‘chicken’ and ‘pork’ having more votes than ‘beef’ and due to ‘chicken’ gaining more votes than ‘pork’, ‘chicken’ can be proactively selected since it is the highest gaining white meat. Various techniques involving inference, predictive technology, artificial intelligence and/or error-correction can be employed to relate differing responses which may be misspelled and/or formatted differently to provide for more accuracy with respect to the intent of the sampled responses. Thus, the system 100 can assist a couple with determining a menu for their wedding. In one embodiment, the system 100 is used to in making a collaborative business decision. In one embodiment, the system 100 is used to in making a collaborative personal decision.

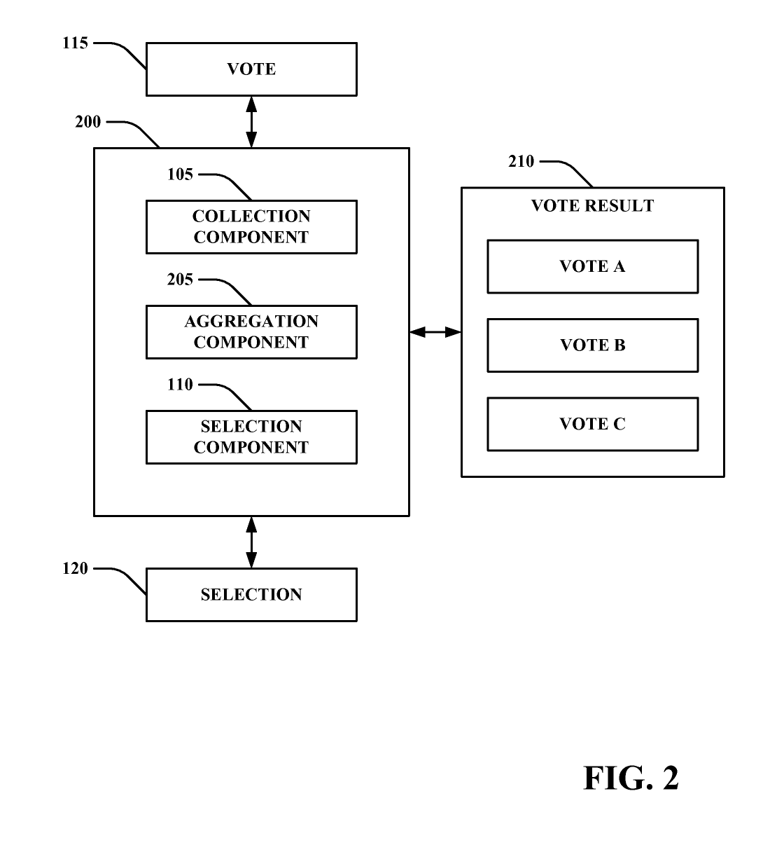

FIG. 2 illustrates one embodiment of a system 200 that includes an aggregation component 205. The system 200 includes the collection component 105 and the selection component 110 in addition to the aggregation component 205. The aggregation component 205 can be configured to aggregate the vote 115 into a vote result 210 after the vote 115 is obtained (e.g., by the collection component 105). The selection component 110 can be configured to make a selection 120 based, at least in part, on the vote result 210 (e.g., shown with votes A, B, and C).

In a collaborative decision environment, a selection can be made based on votes compiled from a number of different entities. These votes can be compiled together into the vote result 210. For example, the collection component 105 can gather a number of votes. The aggregation component 205 can evaluate individual votes to determine to what decision these votes apply, if an individual vote (e.g., the vote 115) is already represented in the vote result 210, and others. Based on the evaluation from the aggregation component 205, the aggregation component 205 can identify an appropriate vote result, place the individual vote in the appropriately identified vote result, discard the individual vote, cause the individual vote to transfer to an appropriate destination (e.g., if the individual vote should be evaluated by a different system), and others. In one embodiment, the aggregation component 205 can evaluate multiple votes simultaneously and/or evaluate a group of votes together where the group of votes are placed into the vote result 210.

In one embodiment, the selection component 110 initially makes the selection 120. As more votes are added to the vote result 210, the vote result can change. Based on this change, the selection component 120 can modify and/or replace the selection 120 to accurately reflect the vote result 210.

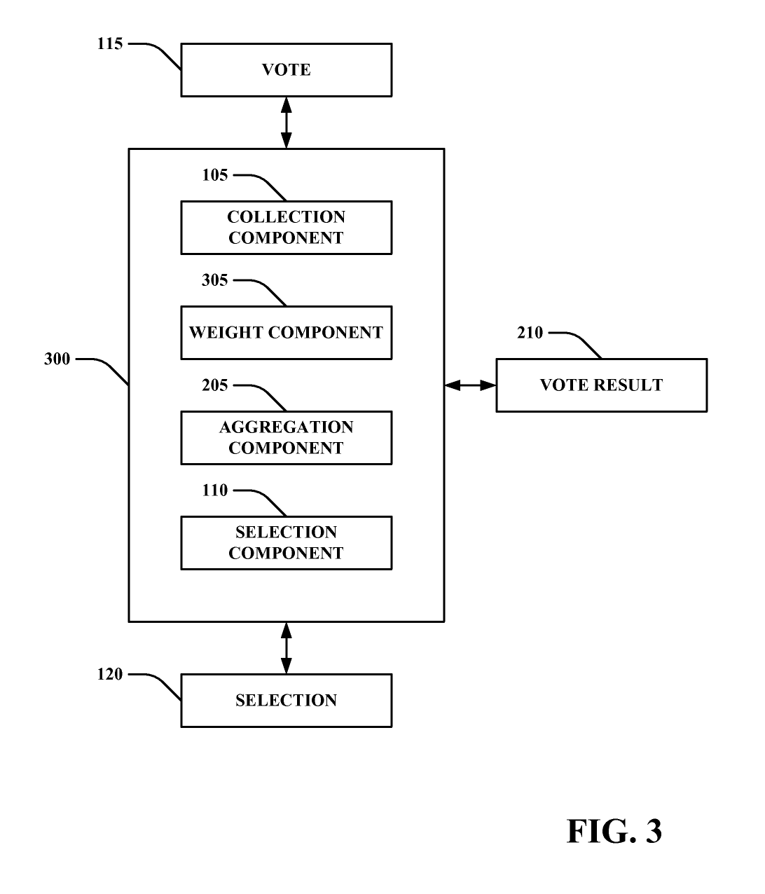

FIG. 3 illustrates one embodiment of a system 300 that includes a weight component 305. In addition, the system 300 also includes the collection component 105, the aggregation component 205, and the selection component 110. The weight component 305 can be configured to apply a weight factor to the vote 115 obtained by the collection component. Aggregation of the vote 115 into the vote result 210 can be is based, at least in part, on the weight factor (e.g., aggregation performed by the aggregation component 205).

In one embodiment, different votes can have different weight factors applied. In one example, a voting party is part of a membership organization in order to have their vote counted and/or be able to vote on a collaborative decision. A vote from a voting party that is not part of the membership organization can be discarded. The membership organization can have different levels of hierarchy and a voting party's vote can be given a different weight based on their level. In one instance, a vote from a higher level member can be given more weight than a vote from a lower level member. Thus, this is one example of where the weight factor can be based, at least in part, on a membership level of a source of the vote 115. It is to be appreciated that this is merely an example showing when the weight factor can be based, at least in part, on a membership level of a source of the vote 115.

In one embodiment, votes can have different weights applied to them (e.g., applied by a voting entity). In one example, a voting party can be invited to pay a sum in order for their vote to be given more weight. Various cost levels can be associated with giving the vote 115 different amounts of weight. The weight component 305 can identify an amount paid, ensure that the amount is paid, apply a weight amount to the vote 115, ensure that the aggregation component 205 aggregates the vote 115 in the vote result 210 with the appropriate weight, and others. In one illustrative instance, a voting party can create a system allowing the option to cast either a free vote or pay an amount of money for a vote. A vote that is associated with the amount of money can be provided additional weight (e.g., be aggregated or counted twice or more in comparison to single treatment of a free vote) the aggregation component.

In one embodiment, votes can be give weight based, at least in part, on an amount of previous votes a voting party has made. In one embodiment, votes can be give weight based, at least in part, on an amount of previous votes a voting party has made that were for a selection ultimately made. In one embodiment, votes can be given weight based, at least in part, on demographic information of a voting entity (e.g., votes from a target demographic of a company can be given a greater weight factor). It is to be appreciated that this is not an exhaustive list of weight factor basis.

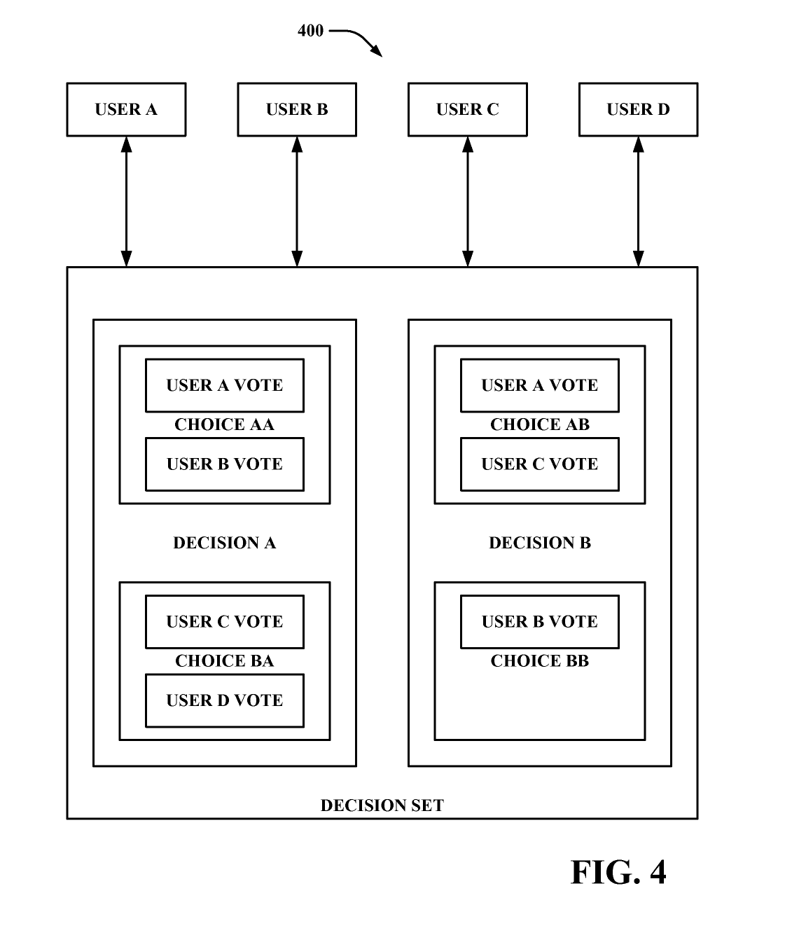

FIG. 4 illustrates one embodiment of an environment 400 of how a decision can be made. In one example, the environment 400 can illustrate operation of the systems 100 of FIG. 1, 200 of FIG. 2, and/or 300 of FIG. 3. A group of users (e.g., users A-D) can vote on two decisions (decision A-B), where the two decisions are part of the decision set. ‘Decision A’ can have two choices (e.g., ‘choice AA’ and ‘choice BA’) while decision B also has two choices (e.g., ‘choice AB’ and ‘choice BB’). It is to be appreciated that decisions in a decision set can have different numbers of choices.

The collection component 105 of FIG. 2 can collect votes (e.g., a vote from ‘user A’ for ‘choice AA’ on ‘decision A’). The aggregation component 205 of FIG. 2 can identify that a vote from ‘user A’ on ‘decision A’ is for ‘choice AA.’ The aggregation component 205 can cause the vote result 210 of FIG. 2 to represent that a vote from ‘user A’ on ‘decision A’ is for ‘choice AA.’ In one example, the environment 400 represents that for ‘decision B’ ‘choice AB’ has more votes than ‘choice BB.’ The selection component 110 of FIG. 2 can select ‘choice AB’ since ‘choice AB’ has more votes than ‘choice BB.’ In one example, the environment 400 represents that ‘decision A’ is tied with choices having an equal number of votes. In this example, the system 200 of FIG. 2 can solicit more votes, user artificial intelligence to break the tie, defer to a manager and/or designated entity to break the tie, and others that will be apparent to one of ordinary skill in the art given a particular decision context.

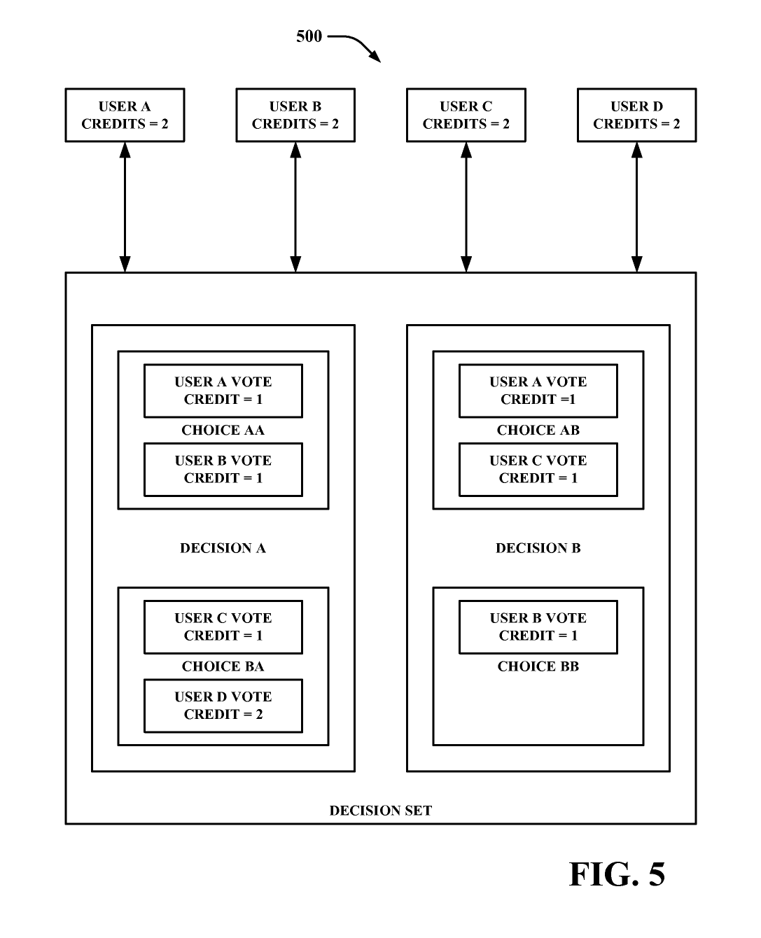

FIG. 5 illustrates one embodiment of an environment 500 of how a decision can be made with weights. In one example, the environment 500 can illustrate operation of the systems 100 of FIG. 1, 200 of FIG. 2, and/or 300 of FIG. 3. A group of users (e.g., users A-D) can vote on two decisions (decision A-B), where the two decisions are part of the decision set and where the users have credits that can be used to give weight to a vote. While users A-D are illustrated as having equal credit amounts (e.g., two credits), it is to be appreciated that users can have different credit amounts.

Users can apply different credits to different votes. For example, ‘user D’ can apply two credits to a vote for ‘choice BA’ for ‘decision A.’ With ‘decision A’, ‘choice BA’ can be selected by the selection component 110 of FIG. 1 because ‘choice BA’ has 3 credits while ‘choice AA’ has 2 credits despite ‘choice AA’ and ‘choice BA’ having equal votes. A weight factor for a vote of ‘user D’ on ‘choice BA’ can be higher than a vote of ‘user C’ for ‘choice BA’ and can be higher than a vote of ‘user A’ on ‘choice AB.’

Credits, weights and votes can be applied in a variety of ways. In an embodiment, voting can involve more than one decision, but can be executed in a cumulative fashion, such that a person might apply all their influence to a single decision and have no input on others. In one embodiment, credit is first applied to a particular vote before applying to others. In one embodiment, the specific votes are determined by the system, even if users are weighted or credited differently. These embodiments merely represent possible examples of voting schemes, and others will be apparent to those skilled in the art.

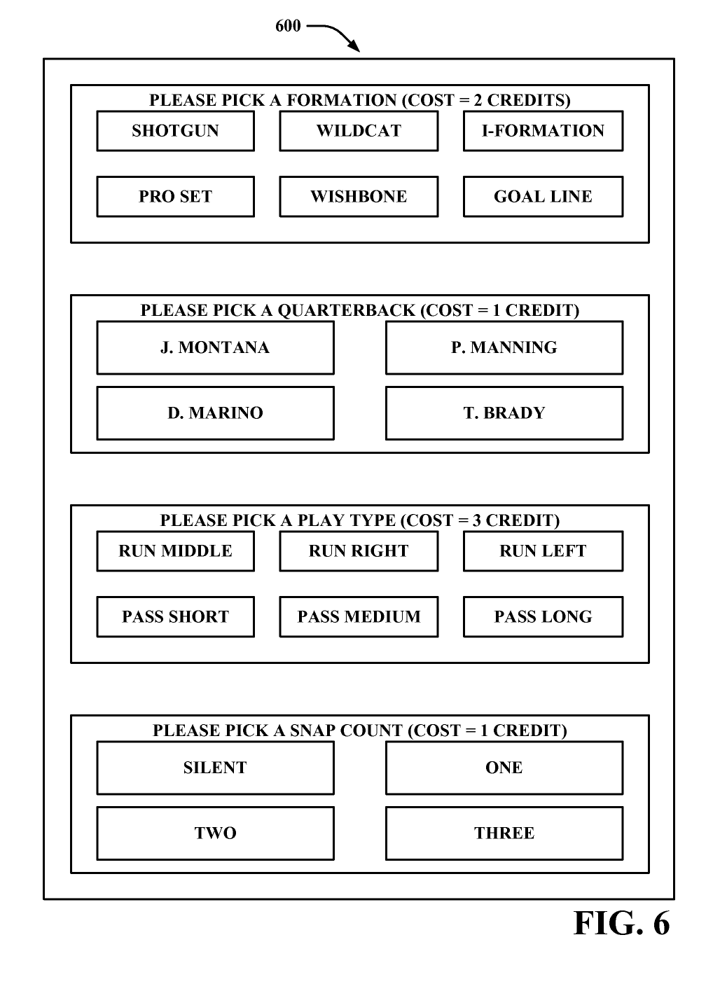

FIG. 6 illustrates one embodiment of an interface 600. In one example, the collection component 105 of FIG. 1 can include an interface component that causes an interface (e.g., the interface 600) to be displayed. In one example, a person can be watching a football game (e.g., American football). The person can hold a device that presents the interface 600. The interface can be used to enable fans to make real-time decisions in football games. For example, these decisions can be for a formation to be selected, a player to play a certain position, for a play type, for a snap count, and others. In an embodiment, different decisions can have different associated costs, and costs can be weighted based on contextual aspects relating to the parties involved (e.g., premium cable plans cost more to vote, voters not in home-town area charged more, voters with bad records charged more/weighted less, voters suspected of trying to sabotage may have increasing costs, etc.). While an interface for football is shown as interface 600, it is to be appreciated that the interface 600 can be used in other scenarios, provide other information, and others.

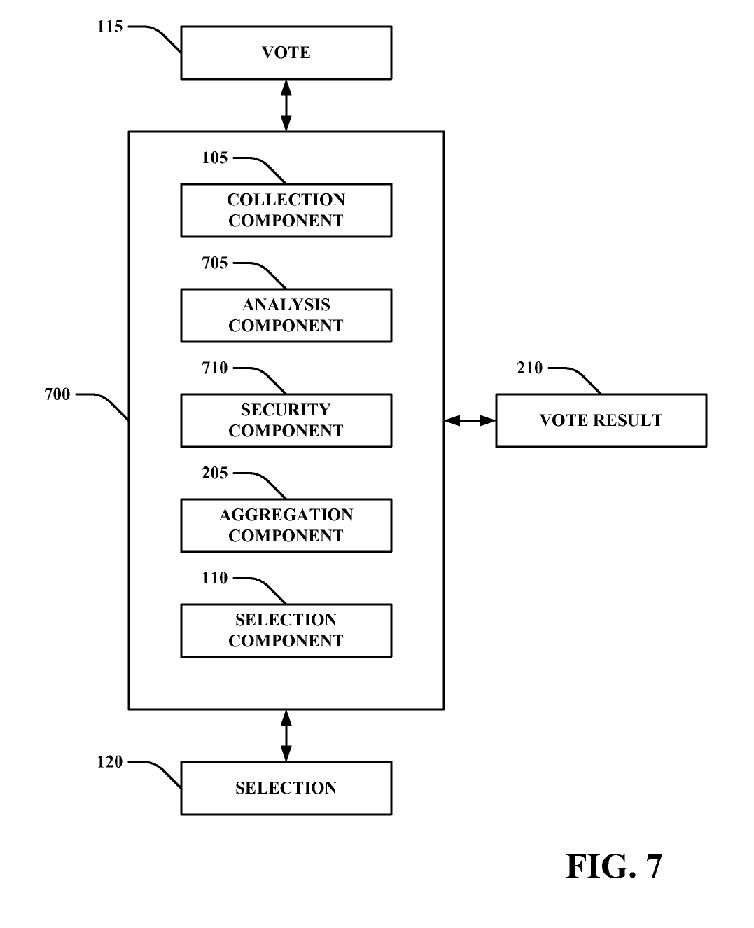

FIG. 7 illustrates one embodiment of a system 700 with an analysis component 705 and a security component 710. The system 700 is also illustrated with the collection component 105, the aggregation component 205, and the selection component 110. The vote 115 can be obtained by the collection component 105. The analysis component 705 can be configured to perform a security evaluation on the vote 115. The security evaluation can produce a vote security evaluation result. The security component 710 can be configured to make a vote determination on if the vote 115 should be aggregated into the vote result 210 based, at least in part, on the vote security evaluation result. The vote 115 can be aggregated into the vote result 210 in response to the vote determination being positive (e.g., the security component determining that the vote 115 is authorized to be part of the vote result 210).

Collaborative decisions can be a highly sensitive area. In one example, a hardware store can have request customers to at least weigh in on a decision for what power drills to carry in-store and/or how to arrange product placement on shelves. The hardware store would likely not want their competitors to influence the vote result 210. In one illustrative instance, in order to vote a voting entity (e.g., customers, employees, etc.) can be asked to submit to identity verification, background checks, and others. The analysis component 705 and security component 710 can function to stop/reduce/minimize unauthorized votes from becoming part of the vote result 210 and ultimately influencing the selection 120, stop/reduce/minimize tampering with the vote result 210 or components of the system 700, and others.

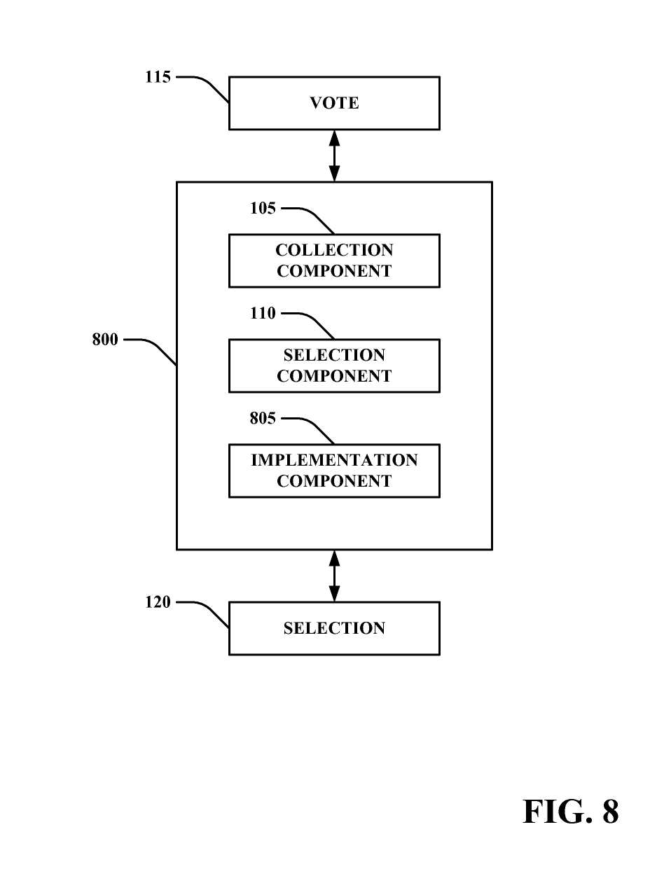

FIG. 8 illustrates one embodiment of a system 800 with an implementation component 810. The system 800 can also include the collection component 105 (e.g., to collect the vote 115) and the selection component 110. The implementation component 805 can be configured to proactively cause the selection 120 to be implemented. In one example, the system 800 can be used in association with a video game first-person shooter. Players can collaboratively vote on what map to play, how the map should be arranged, how long a game should last, a final score to be achieved in order for a team to win, and others. After a voting time period elapses, the selection component 110 can identify selections and the implementation component 805 causes the selections to be implemented. Continuing with the video game first-person shooter example, if the selection is that a barrier is placed on a certain part of a map to protect players from fire, then the implementation component 805 proactively causes the map to render with the barrier. Where users can define such decisions, user level (e.g., administrator, game experience, subscription cost, et ecetera) can be employed to determine what votes occur first; voting can be based on what is pertinent to a current context as opposed to ongoing (e.g. vote on current map takes precedence over points to win); voting can be on a rolling basis (e.g., all votes eventually come up); and others.

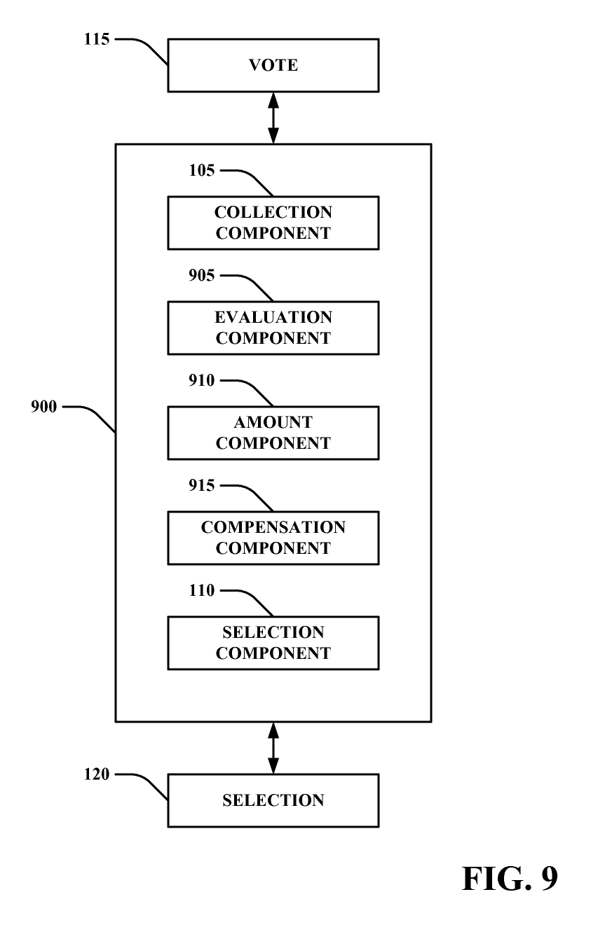

FIG. 9 illustrates one embodiment of a system 900 with an evaluation component 905, an amount component 910, and a compensation component 915. The system 900 can also include the collection component 105 and the selection component 110. The collection component 105 can obtain the vote 115. The evaluation component 905 can be configured to evaluate the vote 115 to produce a vote evaluation result. The amount component 910 can be configured to determine a benefit to compensate a vote provider based, at least in part, on the vote evaluation result. The compensation component 915 can be configured to cause a party (e.g., a vote-provider, a third-party, a charity, and others) to be compensated the benefit.

A company may want to incentivize people to provide votes. The system 900 can function to compensate voting parties. A party can supply the vote 115. The evaluation component 905 can evaluate the vote to determine an identity of the party, a credit card account associated with the party, and others. The amount component 910 can determine how much to compensate the party. In one embodiment, a compensation amount can be flat rate for votes received. In one embodiment, the compensation amount can vary based on a metric (e.g., a vote from a rarely provided demographic group can be compensated more than a vote from a commonly provide demographic group). In one embodiment, the compensation amount is tied to the selection 120 (e.g., the compensation is higher if the vote was for the selection 120, the compensation is higher if the vote was for the selection 120 and the selection 120 is successful, and others).

In one embodiment, the benefit is at least partially financial compensation. In one embodiment, the benefit is at least partially non-financial compensation. In one example, a number of individuals can be part of a communication network. The communication network can allow these individuals to make requests and other individuals can vote on the request. In one example, a network member can ask members for an Asian restaurant to eat at in their neighborhood. Network members that vote can be compensated with an ability to ask their own request (e.g., after one vote, after several votes, etc.). Thus, network members can be encouraged to provide votes because they can make their own requests (e.g., be enabled to make requests, be enabled to make requests for free or at a reduced rate, and others). In one example, different compensation can be provided for different voters (e.g., a first voter is compensated with money while a second voter is compensated with a requesting ability). In one example, a compensation varies among voters (e.g., network members who frequent Asian restaurants may be given greater compensation than network members that rarely eat at Asian restaurants).

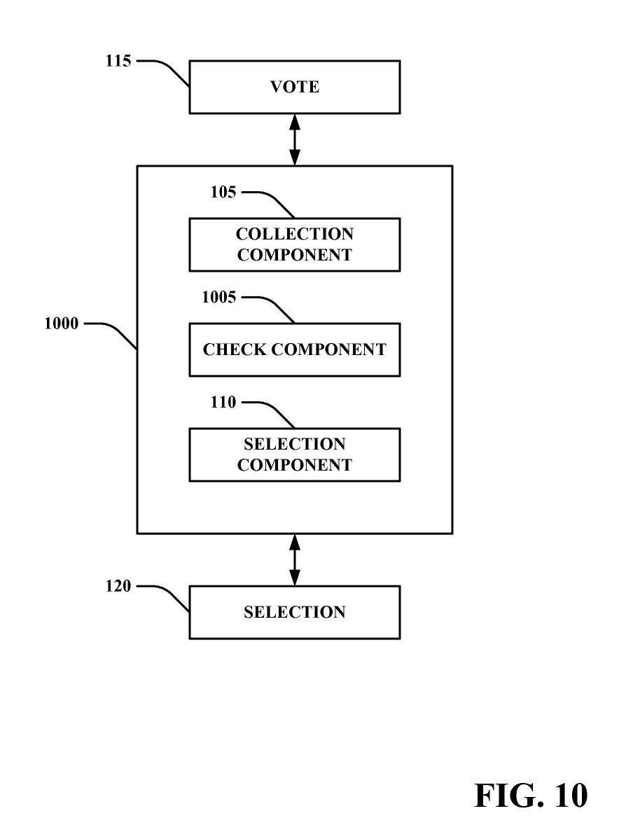

FIG. 10 illustrates one embodiment of a system 1000 with a check component 1005. The system 1000 can also include a collection component 105 and a selection component 110. The check component 1005 can be configured to verify an identity of a vote provider of the vote 115. The vote 115 can be used to make the selection 120 in response to the identity being verified. It can be beneficial to ensure that a party that provides the vote 115 is who the party is representing. In one example, a party can claim that their demographic information meets with desirable demographic information so their vote can be given more weight. In one example, a voting device can be stolen and a stealing party can attempt to vote. Thus, the check component 1005 can be configured to protect voting integrity. In one example, the check component 1005 can monitor voting patterns to proactively identify irregularities. Upon discovering irregularities, the check component 1005 can perform additional verification tasks (e.g., ask security questions), block voting, place a watch order on a party, and others.

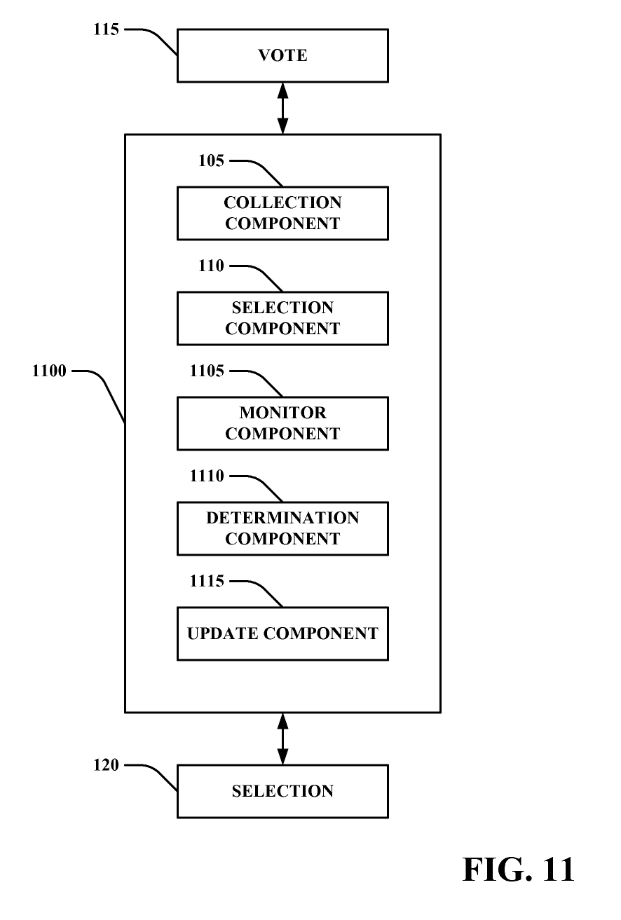

FIG. 11 illustrates one embodiment of a system 1100 with a monitor component 1105, a determination component 1110, and an update component 1115. The system 1000 can also include a collection component 105 and a selection component 110. The selection component 110 can make a selection 120 based, at least in part, on the vote 115. The selection can be implemented (e.g., by the implementation component 805 of FIG. 8, by a person, and others). The monitor component 1105 can be configured to observe an effectiveness level of implementation of the selection 120. The determination component 1110 can be configured to make an update determination on if a database that supplies the vote should be updated, where the update determination is based, at least in part, on the effectiveness level. The update component 1115 can be configured to update the database in response to the update determination being made that the database should be updated.

In one embodiment, the system 1100 can operate in an environment where multiple members are part of a communication network. Members can ask questions to the communication network and members can provide responses. In one example, the vote 115 is a response to a question (e.g., open-ended question, closed-ended question, multiple-choice question, true-false question, a personal written text response, and others). As responses to questions are gathered, artificial intelligence can be used to draw inferences, conclusions, and the like from the responses. These inferences, conclusions, and the like can be used to populate the database. For example, a member can ask ‘What is a good Polish restaurant in Cleveland, Ohio?’ A majority of responses can state ‘Sokolowskis University Inn.’ The system 1100 can evaluate this question and response and populate the database with an entry. A subsequent time a member asks ‘what is a good Polish restaurant in Cleveland, Ohio?’, the database can respond as opposed to asking members. In one example, a similar question such as ‘What is a good Eastern European restaurant in Cleveland, Ohio?’ can be answered from the database even if this exact question does not have an asking history. Techniques including inference, artificial intelligence, error-correction and others can be employed to associate similar questions that may be answered using the same data. Thus, the member responses can be used to populate the database and/or member responses (e.g., member responses from a collaborative decision answering a question) can be used as a backup if a database is not informed enough to provide a response. Additionally, ‘Sokolowskis University Inn’ can be designated as the selection 120 and the selection 120 can be presented to a requesting member, members that subscribe to a certain feed, on a website, and others.

In one embodiment, the system 1100 can function to monitor the database to ensure that the database is up-to-date, accurate, appropriately reflects voting of the members, and others. In one example, the database can be populated with a piece of information. For example, in response to the question ‘What is a nice beach to visit in around Cleveland, Ohio?’ an initial response can be ‘Edgewater State Park.’ However, community members may later review ‘Edgewater Beach’ and it can be given poor reviews. Thus, the actual community may ultimately feel ‘Huntington Beach Park’ is a better beach and/or over time opinions may change. This may be reflected by responses to similar questions, outside reviews provided by members, actual beaches visited by community members, and other information. The determination component 1110 can decide that the ‘Edgewater State Park’ entry is not accurate and the update component 1115 can change an entry in the database to reflect ‘Huntington Beach Park.’

In one embodiment, community membership can change and the system 1100 can change to reflect the community. In one example, an initial member community can prefer ‘Edgewater State Park’ over ‘Huntington Beach Park.’ However, some members could leave the community, new members could going the community, and others. Based on this change, a subsequent member community can prefer ‘Huntington Beach Park’ over ‘Edgewater State Park’ and the system 1100 can reflect this change in the database.

In one embodiment, databases of different communities can communicate with one another, share information, and others to produce a richer and robust knowledge set. In one embodiment, even if an answer is available in the database, the system 1100 can refer to the community for an answer to ensure that the database accurately reflects the opinion of the community. In one embodiment, the database can use a threshold for a minimum number of votes for a database entry to be made. In one example, a community can have thousands of members in the Cleveland, Ohio area. However, in response to ‘What is a nice beach to visit in around Cleveland, Ohio?’, three members may vote. Since this is a relatively small sampling, the vote may not be enough to warrant a database entry. The vote can be saved in the database and aggregated with other votes at a later time (e.g., by the aggregation component 205 of FIG. 2).

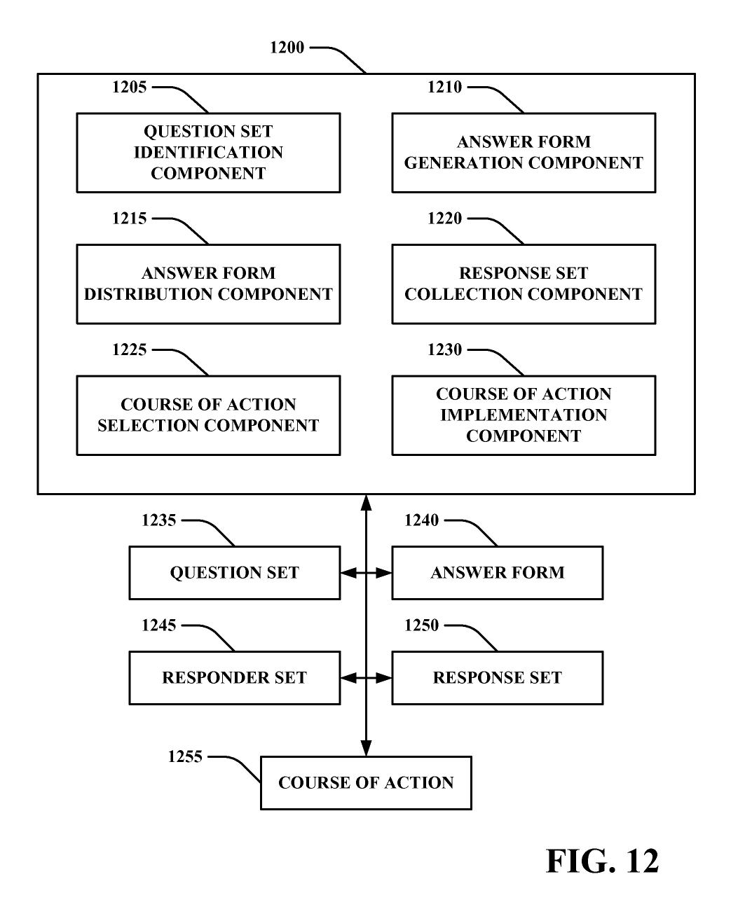

FIG. 12 illustrates one embodiment of a system 1200 with a question set identification component 1205, an answer form generation component 1210, an answer form distribution component 1215, a response set collection component 1220, a course of actions election component 1225, and a course of action implementation component 1230. A situation can be analyzed and a determination can be made that the situation can benefit from a collaborative decision experience. For example, the determination can be that knowledge of what a public feels about an issue can be useful information regarding handling the situation. The question set identification component 1205 can identify a question set 1235.

In one example, the situation can be which website format to use and the question set 1235 can be ‘which website format should be used?’ The question set 1235 can include one or more questions. Based on questions included in the question set 1235, the answer form generation component 1210 can generate an answer form 1240, where the answer form 1240 facilitates a response to the question set 1235. The answer form 1240 can be a collaborative decision answer form. In one embodiment, the answer form generation component 1210 evaluates the question set 1235 and determines a better or optimal answer form. An example answer form 1240 can be represented as shown on the interface 600 of FIG. 6 and the question set 1235 can be a football-based question set.

In one embodiment, the question set 1235 comprises at least two inter-related questions that applies to a business decision. In one example, a first question and a second question can be at least loosely related to a topic. In one example, a second question depends on an answer provided by an answerer of a first question. In one embodiment, the second question depends on a collective answer provided by community members to the first question.

The answer form distribution component 1215 can cause the answer form 1240 to be distributed to a responder set 1245. In one embodiment, the answer form distribution component 1215 evaluates the question set 1235, answer form 1240, potential responder sets, individuals that can potentially included in the responder set 1245, and others. Based on a result of this evaluation, the answer form distribution component 1215 can define members of the responder set 1245. In one embodiment, the responder set 1245 is pre-determined group of responders (e.g., customers that agree to respond to questions).

The answer form 1240 can be sent out to individual members of the responder set 1245. At least some of the individual members can at least partially complete the answer form 1240 and cause the at least partially completed answer forms to be transferred back to the system 1200. These at least partially completed answer forms (e.g., one or more partially completed answer form) can be considered part of a response set 1250. The response set collection component 1220 can collect the response set 1250 from the responder set 1245, where the response set 1250 is produced by the responder set 1245 by at least partially completing the collaborative decision answer form.

Based, at least in part on the response set 1250, the course of action selection component 1225 can select a course of action 1255 (e.g., a course of action for the situation). In one embodiment, the course of action implementation component 1230 causes the course of action 1255 to be proactively implemented. In one embodiment, the course of action 1255 is presented to a manager that can use the course of action in consideration of how to handle the situation (e.g., follow the course of action 1255, create a modified course of action based on the course of action 1255, ignore the course of action, and others) and/or the manager can be provided the question set 1235 and/or answer form 1240.

In one embodiment, the question set 1235 is a randomly selection set of questions from a question database. In one example, a company can request that ten questions be answered. However, in order to not overwhelm the responder set 1245, individual members of the responder set are asked two questions out of the ten in their answer form 1240. In one example, questions can be selected randomly, be matched with voting histories, be matched based on demographic information, and others.

In one embodiment, the system 1200 operates in a community member environment. In one example, a network member submits the question set 1235. Example questions an individual member can ask can be where to eat, if a person should stay with their significant other, trivia questions, questions to try to find a mate, and others. In one embodiment, the course of action 1255 comprises notifying a network member of a suggested answer to the question set (e.g., notify the individual member of answers to their question set 1235), where the suggested answer is based, at least in part, on the response set 1250. In one embodiment, in addition to answers to the question set 1235,

In one embodiment, the course of action 1255 is raw data of the response set, where a highest scoring answer is indicated (e.g., thus, the highest scoring answer can indicate a course of action the individual member should take). In one embodiment, the question set 1235 can be a question to community members on what mobile device application an individual member should download in view of the individual member liking video games and boxing. The response set 1250 can indicate a specific boxing video game application and the course of action can be to proactively download the specific boxing video game onto a mobile device of the individual member.

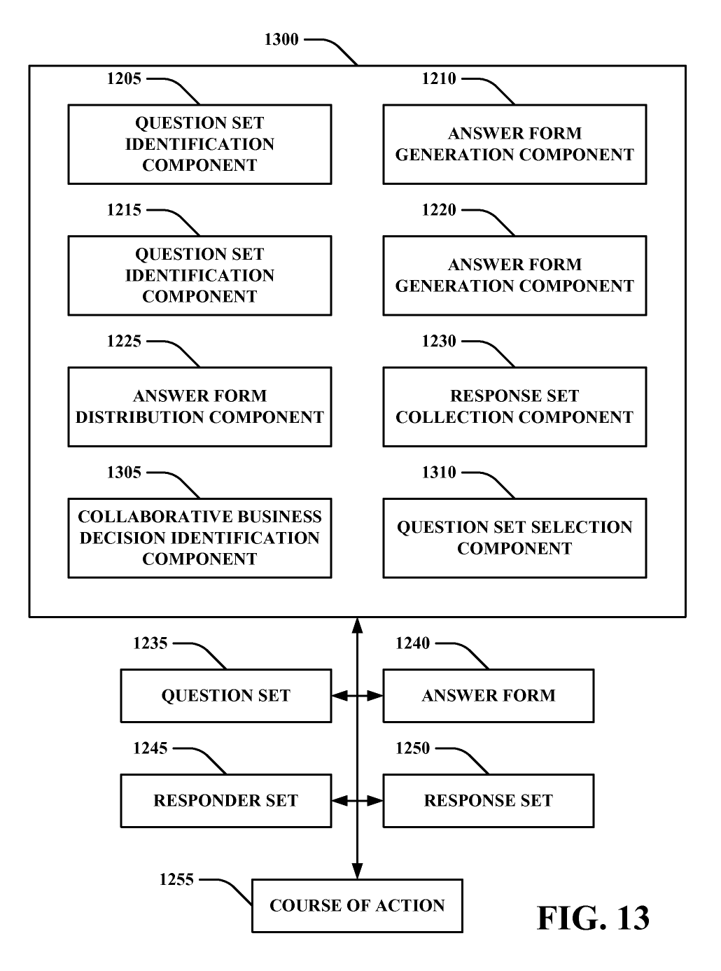

FIG. 13 illustrates one embodiment of a system 1300 with a collaborative business decision identification component 1305 and a question set selection component 1310. The system 1300 also includes the question set identification component 1205, the answer form generation component 1210, the answer form distribution component 1215, the response set collection component 1220, the course of actions election component 1225, and the course of action implementation component 1230. The system 1300 can monitor operation of a business with the collaborative business decision identification component 1305. The collaborative business decision identification component 1305 can proactively identify a collaborative business decision. The question set selection component 1310 can select the question set 1235, where the course of action 1255 is implemented to resolve the collaborative business decision.

In one example, a business can change a format for a website used to purchase items. The collaborative business decision identification component 1305 can monitor the website and determine that the website is receiving less business and/or that the reason for less business may be because of the format change. In response to this determination, the question set selection component 1310 can create the question set 1235 and cause the question set 1235 to be represented in the answer form 1240 (e.g., the answer form 1240 can include at least one question from the question set 1235, the answer form 1240 can be structured to obtain answers to at least one question of the question set 1235, and others). For example, the question set 1235 can include the question ‘should the website be changed back?’ and the answer form 1240 presents this question and enables selection of ‘yes’ or ‘no.’ The answer form 1240 can be sent to the responder set 1245 and the responder set 1245 can supply a response set 1250 to the question set 1235 by way of the answer form 1240. Based, at least in part, on the response set 1250, a course of action 1255 can be implemented, shown to a manager, and others. In one example, if the response set indicates the website should be changed back, the response set collection component 1230 can cause the website to proactively change back such that the course of action 1255 is proactively implemented.

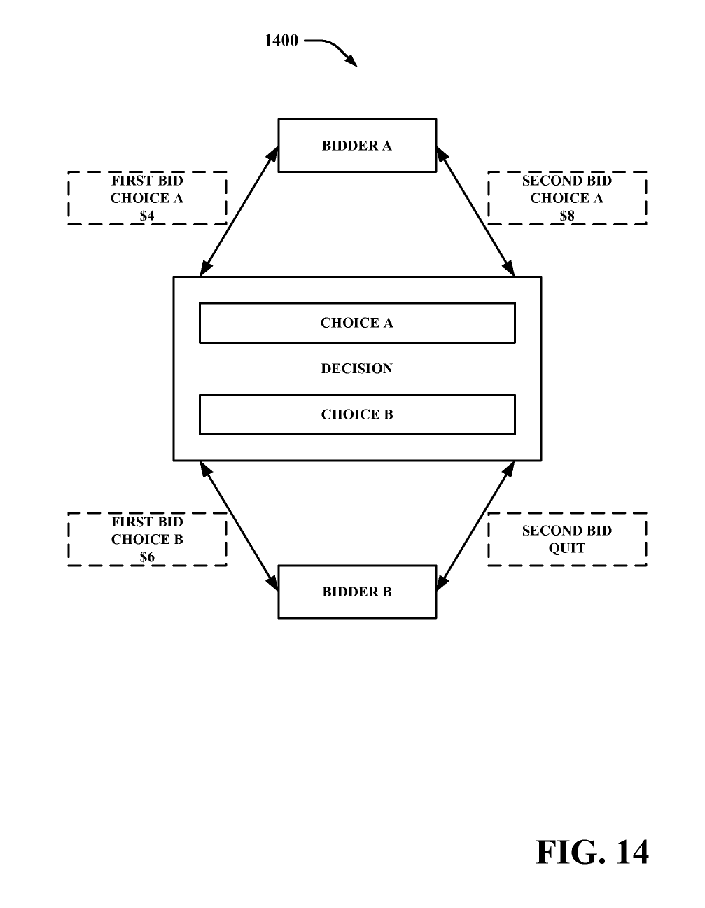

FIG. 14 illustrates one embodiment of an environment 1400 where a bidding structure can be used. A collaborative decision can have different choices. In one example, the decision can have a ‘choice A’ and a ‘choice B.’ In this example, two users, ‘user A’ and ‘user B’ can bit to determine who makes the choice. In one embodiment, ‘bidder A’ and ‘bidder B’ submit bids. A bidder that has a highest bid wins. If bids tie, then a tiebreaker can be used (e.g., artificial intelligence can determine a winner, a random winner is selected, bids are discarded, bidders can re-bid being informed that a tie occurred, and others).

In one embodiment, bidding can occur in rounds. In one example, ‘bidder A’ and ‘bidder B’ submit first bids. In this example, ‘bidder A’ can bid $4 while ‘bidder B’ can bid $6. ‘Bidder A’ can be given a selection to make a second bid or quit. If ‘bidder A’ makes a second bid that beat the $6 bid of ‘bidder b’, then ‘bidder B’ can make another bid or quit. This can continue until a winner is determined, a threshold amount is reached, a threshold number of bids is reached, and others. In one example, bids are made along with choices. If the bids match choices, then a higher bidder for that choice can win. In one example, one of the bidders (e.g., ‘bidder A’) makes a first bid and then another bidder (e.g., ‘bidder B’) can respond with another bid. While shown with one decision, two choices, two bidders, and two bids per bidder, it is to be appreciated that more complex arrangements can be practiced in accordance with these aspects.

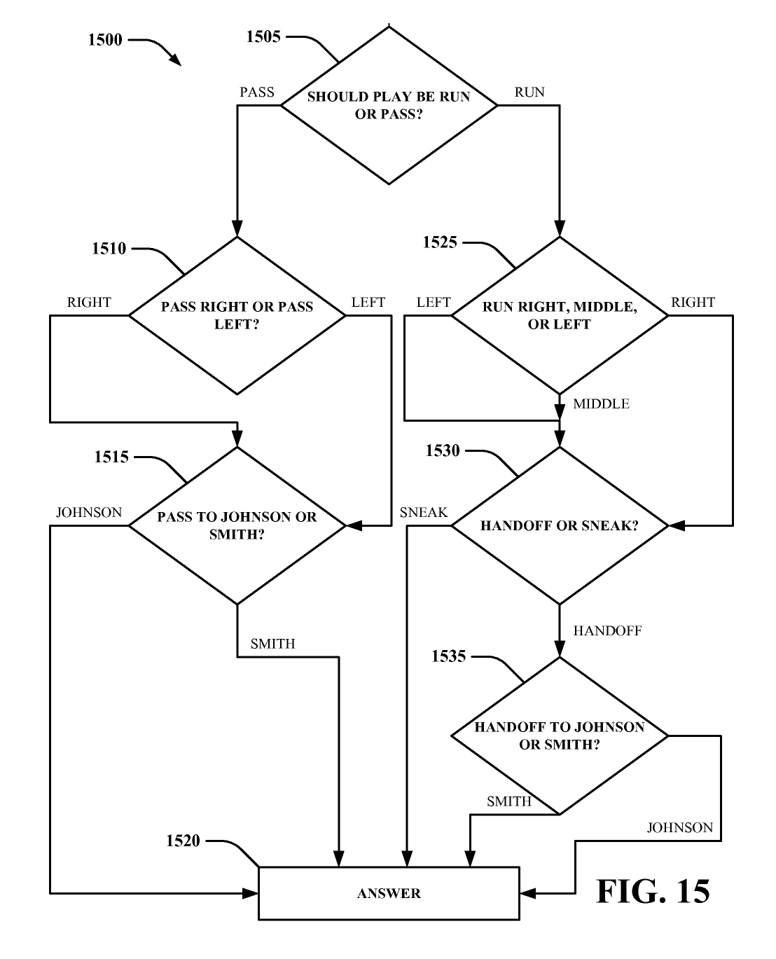

FIG. 15 illustrates one embodiment of a decision tree 1500 for a question set. In one embodiment, the question set is the question set 1235 of FIG. 12 and/or a question set presented to gather the vote 115 of FIG. 1. The decision tree 1500 can relate to, for example, a football decision process. In one example, a number of organizations (e.g., businesses, social clubs, fraternities, individuals, and others) can compete against each other where the organizations make collaborative decisions. In one example, the organizations can play a computer football game (e.g., online football game, fantasy football game, and others). The organizations can use collaborative decision making to decide outcomes of the game. In one example, two computer teams can play against each other and the organizations can select starting line-ups, play calls, formations, etc. These selections can be proactively implemented and a game can be played in this manner.

The decision tree 1500 can begin by asking a party if a run or play should be called at choice 1505. If the party selects to pass, then the decision tree 1500 goes to choice 1510 that asks the party what direction the pass should be made—to the right or to the left. Regardless of the outcome of choice 1510, the decision tree 1500 can progress to choice 1515 where a determination on what player is intended to receive a pass. The outcome of choices 1505, 1510, and 1515 can be combined into an answer 1520 (e.g., the vote 120 of FIG. 1, the response set 1250 of FIG. 12, and others). The answer 1520 can be used to cause a play to be run, be aggregated with other answers 1520 (e.g., by the aggregation component 205 of FIG. 2), and others.

Returning to choice 1505, if the party selects to run, then the decision tree 1500 can progress to choice 1525 to decide a direction of the run. Regardless of the outcome of choice 1525, the decision tree 1500 can proceed to choice 1530 to determine if the run is a handoff or a sneak (e.g., quarterback sneak). If a sneak is selected, then a determination on who receives the ball is not appropriate since the quarterback who already gets the ball runs with the ball. Therefore, if the sneak is selected, the decision tree 1500 can progress to the answer 1520. If the handoff is selected, then the decision tree can proceed to choice 1535 to determine who receives the handoff and this outcome of choice 1535 can follow to the answer 1520. In one embodiment, choices 1515 and 1535 are merged together into one choice (e.g., ‘who receives the ball’). Thus, previously divergent paths of the decision tree 1500 can converge and/or re-converge.

It is to be appreciated that the decision tree 1500 is not intended to limit scope or application of aspects disclosed herein and examples shown with the decision tree 1500 and examples disclosed elsewhere herein are not intended to be exhaustive. For example, while choice 1505 shows running or passing as options, an initial choice could also include punting, kicking a field goal, running a trick play, and others.

In one embodiment, collaborative decision making can be used in a competition amount teams made of individuals. For example, a group of chess players from one organization (e.g., chess club, nation, school, an individual, etc.) can play a game of chess against another organization. Openings, specific moves, and the like can be decided collaboratively and at least one chess game can be played in this manner.

Where a vote or decision is time-sensitive, votes can be cast in advance, or provisional votes can be made that will be entered unless changed later. A cutoff time can be set for votes, and votes missing such cutoff can be excluded with or without refund. Other means of managing the time-sensitivity of realtime voting will be appreciated one of ordinary skill in the art as well.

The following methodologies are described with reference to figures depicting the methodologies as a series of blocks. These methodologies may be referred to as methods, processes, and others. While shown as a series of blocks, it is to be appreciated that the blocks can occur in different orders and/or concurrently with other blocks. Additionally, blocks may not be required to perform a methodology. For example, if an example methodology shows blocks 1, 2, 3, and 4, it may be possible for the methodology to function with blocks 1-2-4, 1-2, 3-1-4, 2, 1-2-3-4, and others. Blocks may be wholly omitted, re-ordered, repeated or appear in combinations not depicted. Individual blocks or groups of blocks may additionally be combined or separated into multiple components. Furthermore, additional and/or alternative methodologies can employ additional, not illustrated blocks, or supplemental blocks not pictured can be employed in some models or diagrams without deviating from the spirit of the features. In addition, at least a portion of the methodologies described herein may be practiced on a computer-readable medium storing computer-executable instructions that when executed by a computer cause the computer to perform a methodology.

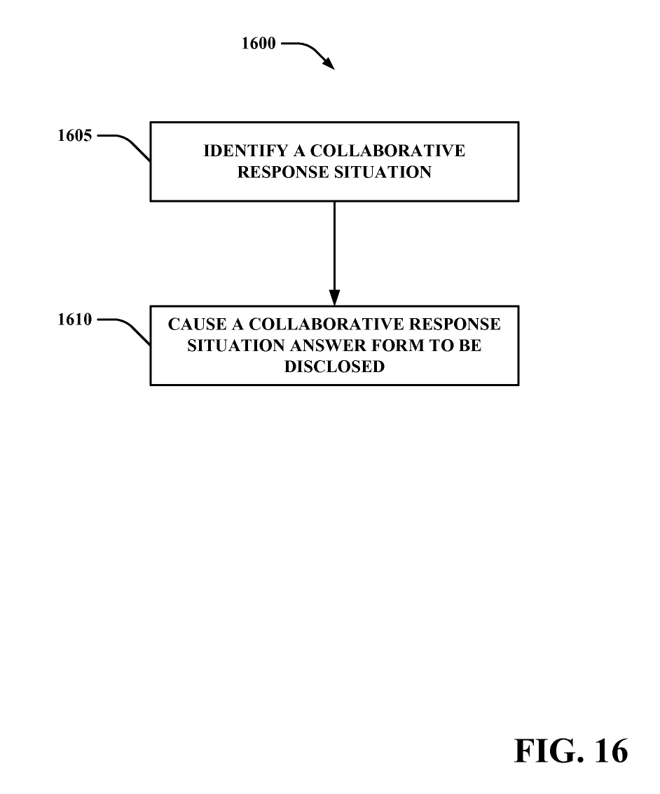

FIG. 16 illustrates one embodiment of a method 1600 for collaborative situation responding. At 1605, a collaborative response situation can be identified. For example, a situation that may benefit for a collaborative response can be identified proactively. In one example, a person can ask a database what shops sell movies at an airport. The database may not have an answer to this question, so an identification can occur that a collaborative response should be gathered.

At 1610, a collaborative response situation answer form can be caused to be disclosed. The collaborative response situation answer form can facilitate determining an answer for the collaborative response situation. Returning to the movie selling example, an answer form asking community members if a store in the airport sells movies, asking community members to rate stores that sell movies, and others can be disclosed. In one embodiment, pre-made answer forms can be retained in a database and when the collaborative response situation is identified, at least one pre-made answer form can be disclosed to one or more parties. The collaborative response situation can be a business situation, a personal situation, and others. In one embodiment, the collaborative response situation is a business decision for a business entity. In one embodiment, the collaborative response situation is a question asked by an individual network member.

After being disclosed, at least partially completed collaborative response situation answer forms can be collected. The collected forms can be analyzed and a collaborative response situation solution can be identified. This solution can be communicated to a requesting party, caused to be proactively enacted, and others.

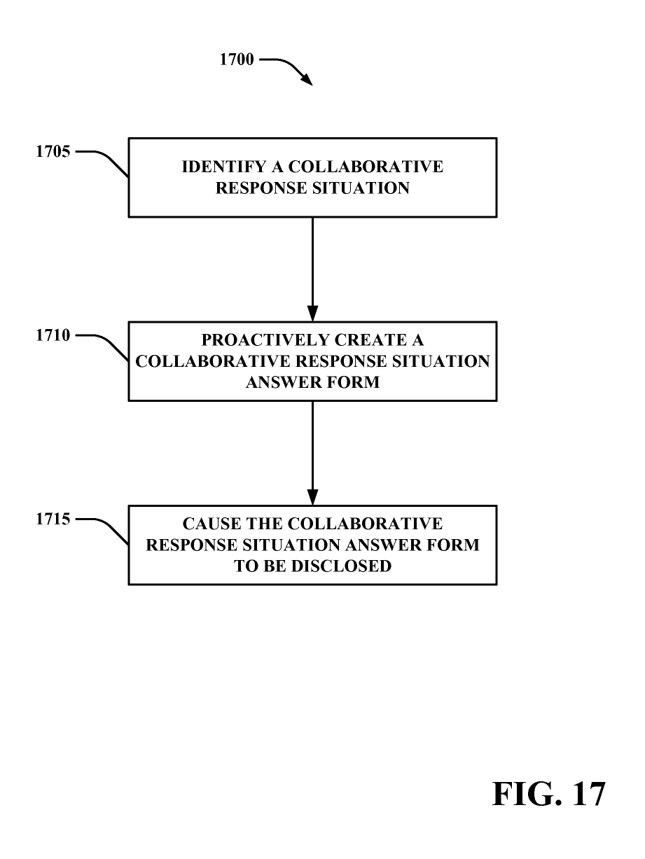

FIG. 17 illustrates one embodiment of a method 1700 for proactively creating a collaborative response situation answer form. At 1705, a collaborative response situation can be identified. In one example, a component on a mobile device can notice that a person has been texting questions to friends on where to eat in a neighborhood. This can be a situation where a collaborative response can help the person find where to eat and thus be identified as a collaborative response situation.

At 1710, there can be proactively creating a collaborative response situation answer form that is caused to be disclosed in response to the collaborative response situation being identified at 1705. In one embodiment, the collaborative response situation is evaluated and based, at least in part, on an evaluation result, the collaborative response situation answer form can be created. In one embodiment, creation of the collaborative response situation answer form comprises identifying questions to be included in the collaborative response situation answer form and transforming raw question data into the collaborative response situation answer form. At 1715, the collaborative response situation answer form can be caused to be disclosed (e.g., to individuals designated (e.g., pre-situation designated, post-situation designated, etc.) by a person that is experiencing the collaborative response situation). Thus, redundant and/or personalized answer forms can be sent to individuals. For example, a collaborative response situation answer form can include a personal greeting for an intended recipient, be formatted based on preferences of the intended recipients, be modifiable so the collaborative response situation answer form can be properly displayed on a device of the intended recipient, and others.

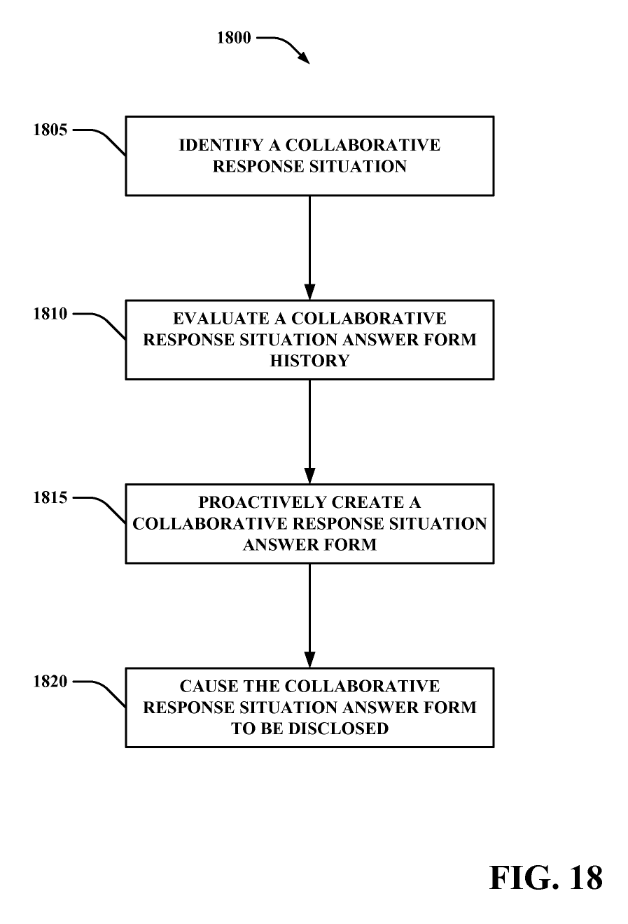

FIG. 18 illustrates one embodiment of a method 1800 for evaluating a collaborative response situation answer form history. At 1805 there can be identifying a collaborative response situation. At 1810 there can be evaluating a collaborative response situation answer form history to produce a history evolution result. At 1815 there is proactively creating the collaborative response situation answer form that is caused to be disclosed in response to the collaborative response situation being identified at 1805. In one embodiment, the history evaluation result is used in proactively creating the collaborative response situation answer form.

In one embodiment, success levels of different answer forms can be evaluated and used to create a more successful answer form (e.g., an answer form more likely to gain a response). In one embodiment, evaluation can occur on how questions are asked in answer forms influence answers and this can be used to generate a more neutral answer form. At 1820 there can be causing the collaborative response situation answer form to be disclosed, where the collaborative response situation answer form facilitates determining an answer for the collaborative response situation.

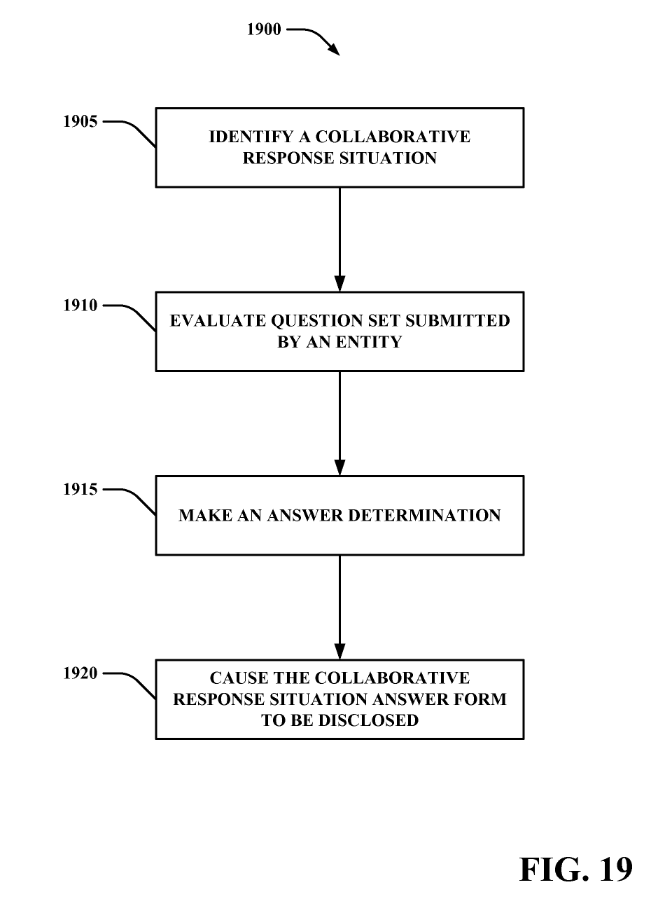

FIG. 19 illustrates one embodiment of a method 1900 for making an answer determination. At 1905 there can be identifying a collaborative response situation. At 1910 there can be evaluating a question set submitted by an entity to produce a question set evaluation result. At 1915 there can be making an answer determination on whether an existing answer to the question is available based, at least in part, on the question set evaluation result. At 1920 there can be causing a collaborative response situation answer form to be disclosed, where the collaborative response situation answer form facilitates determining an answer for the collaborative response situation and where the collaborative response situation answer form is caused to be disclosed in response to the answer determination indicating that the existing answer is not available (e.g., an answer is not available, a suitable answer is not available, an answer with a high enough confidence level is not available, and others).

In one embodiment, it can be financially intensive, processor and memory intensive, and intensive with respect to other associated aspects for a collaborative response situation to be handled by sending out an answer form. When a response to an answer form is collected, the response can be stored in a database. When a similar and/or identical question is presented, a determination can be made if the response stored in the database adequately answers the question (e.g., through use of at least one artificial intelligence technique). If the response stored in the database (e.g., an existing answer) is adequate, then the response can be given as a solution to the collaborative response situation. Thus, even if a situation could benefit from a collaborative response and be classified as a collaborative response situation, the situation may be responded to in a non-collaborative manner. If the database does not include an adequate response to the collaborative response situation, then an answer form can be produced and used to find an answer. The answer can then be populated into the database. In one embodiment, the existing answer can be used to at least partially respond to the collaborative response situation and a response to an answer form can be used to at least partially respond to the collaborative response situation. In one example, the collaborative response situation can be a request to answer two inter-related questions. A first question can be answered with an existing answer while a second question can be answered with a response from the answer form.

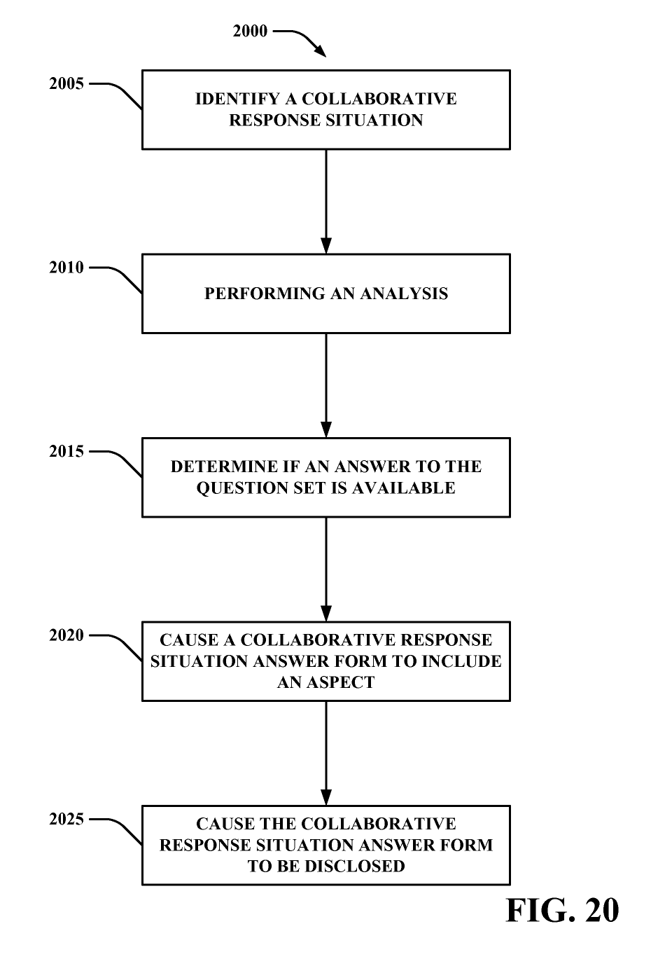

FIG. 20 illustrates one embodiment of a method 2000 for causing at least one aspect to be included in a collaborative response situation form. At 2005 there can be identifying a collaborative response situation. At 2010 there can be performing an analysis on a question set submitted by an entity to solve the collaborative response situation, where the analysis produces a question set analysis result. At 2015 there can be determining if an answer set to the question set is available based, at least in part, on the question set analysis result.

In one example, a person can submit the question set to a system running the method 2000. For example, the question set can include a question ‘What parking lot is both cheap and close to the stadium?’ This question can be analyzed and a determination can be made if information is available to answer the question without resorting to the answer form. In one example, a proactive search of the Internet by a component can determine where parking lot locations are, but may not include up-to-date price information or real-time capacity information. Thus, the analysis can go beyond a scope of the question set proactively (e.g., because capacity is considered while not being explicitly asked because an inference can be drawn that capacity is important).

At 2020, there can be causing a collaborative response situation answer form to include an aspect. In one embodiment, 2020 includes causing the collaborative response situation answer form to include a question indicator. For example, the question indicator can be ‘what parking lot is both cheap and close to the stadium?’ In one embodiment, 2020 includes causing the collaborative response situation answer form to include at least part of the answer set in response to determining that the answer set is available. For example, a database can be searched and a parking lot on a corner of ‘Main and Broadway’ can be identified as an answer to the collaborative response situation. The answer form can include the question indicator and a statement ‘Do you suggest going to the parking lot on the corner of Main and Broadway?’ Thus, the answer form can be specific, guide a responder to a specific idea, and others. In one embodiment, if a response to the statement is no, then a responder can be given an opportunity to provide their own response, be thanked and/or compensated for responding, and others.

In one embodiment, 2020 includes causing the collaborative decision answer form to include an open response portion in response to determining that the answer set is not available. It is to be appreciated that the open response portion can also be included when the answer set is available. If an answer set is not available, then the answer form can include the question ‘What parking lot is both cheap and close to the stadium?’ and the open response portion to enable a network member to enter a response. At 2025 there can be causing a collaborative response situation answer form to be disclosed, where the collaborative response situation answer form facilitates determining an answer for the collaborative response situation.

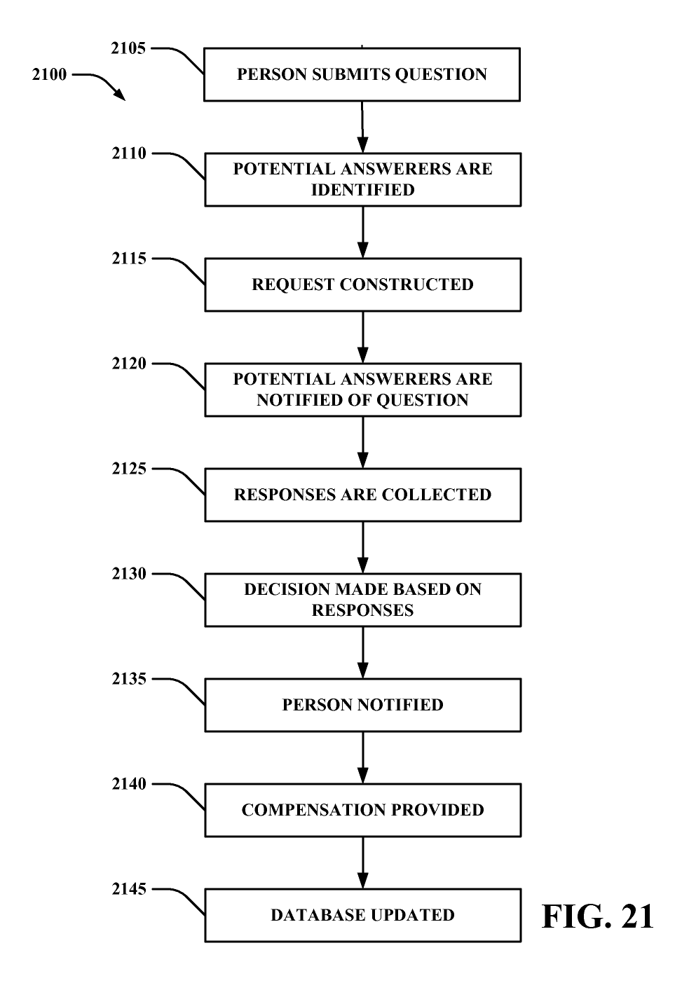

FIG. 21 illustrates one embodiment of a method 2100 for updating a database. At 2105, a person can submit a question (e.g., a person can ask a question that is suited for a collaborative response. At 2110, potential answers to the question can be identified, if available (e.g., from a database). At 2115 a request for an answer can be constructed (e.g., an answer form can be produced). At 2120, potential answerers of the question can be identified and notified of the question (e.g., sent the answer form). Responses to the question can be collected at 2125 and a decision can be made based, at least in part, on the responses at 2130. For example, the decision can be that an answer was not provided (e.g., due to lack of responses) the decision can be an answer to the question, and others. At 2135, the person can be notified of the decision. At 2140, a potential answerer that provides a response can be compensated. In one example, money can be taken from an account of the person and placed into an account of the potential answerer that provides a response. In one example, money from the persons account can be a pre-determined amount and the amount can be distributed in equal or non-equal share to potential answerers that provide a response (e.g., a company operating at least part of the method 2100 can take a percentage of the amount before distribution). At 2145 a database for answering questions can be updated (e.g., with the decision).

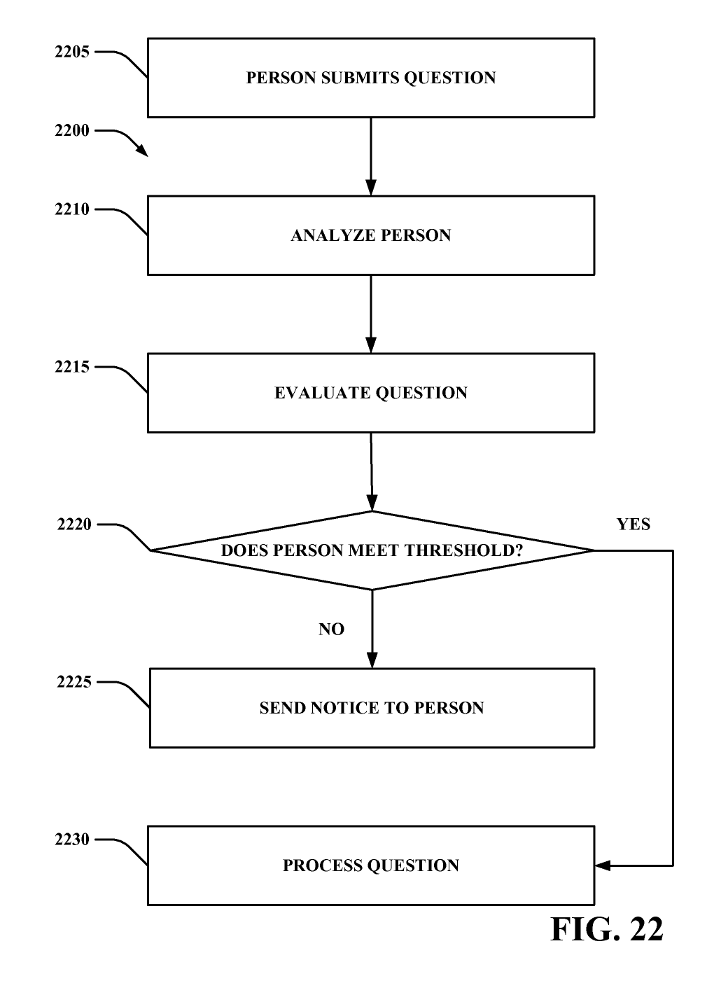

FIG. 22 illustrates one embodiment of a method 2200 for evaluating a person that submits a question. At 2205, a person can submit a question for a collaborative answer. The person 2210 can be analyzed and the question 2215 can be evaluated. A check 2220 can determine if the person meets a threshold. For example, in order for the person to receive a response to the question, the person can be asked to respond to a certain number of questions. In one example, depending on question subject matter, complexity, and others, the threshold can be variable. If the person does not meet the threshold, then a notice can be sent to the person at 2225 that the threshold is not met, how to meet the threshold, an amount of money to pay to ignore the threshold, and others. If the threshold is met (or the person pays the amount), then at 2230 the question can be processed (e.g., sent to a responder set).

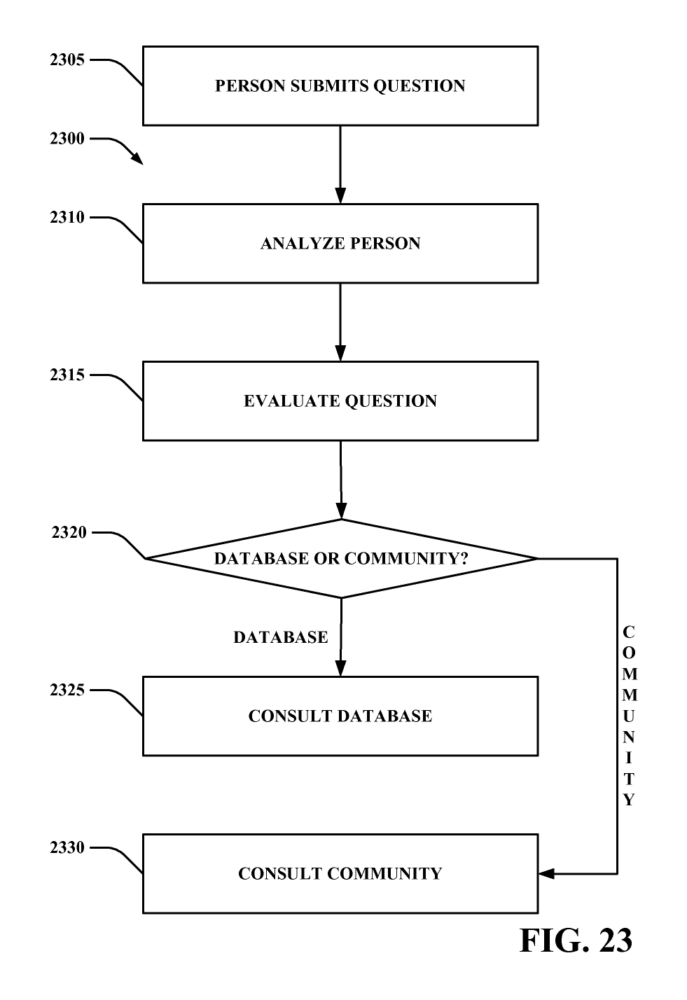

FIG. 23 illustrates one embodiment of a method 2300 for determining a source for answering a question. At 2305 a person can submit a question (e.g., the question can be collected). In one embodiment, the person is a manager of a company and the question is business related. The person can be analyzed at 2310 and the question can be evaluated at 2315. A check 2320 can determine if the question should be answered by a database or by a community. In one embodiment, the check makes the determination based, at least in part, on information in the database, available community members, an amount of money paid by the person, or others. If the database is determined at the check 2320, then the database is consulted for an answer at 2325. If the community is determined at the check 2320, then the community is consulted for the answer at 2330. In one embodiment, regardless of the outcome of the check 2320, if the database does not have the answer, then the community is subsequently consulted and if the community does not have the answer, then the database is consulted.

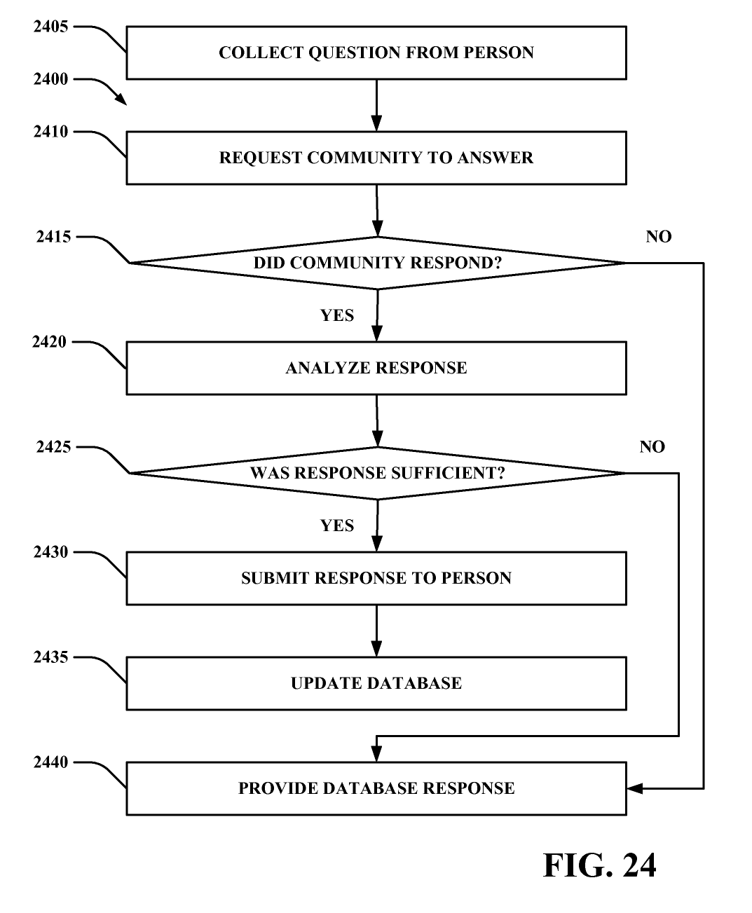

FIG. 24 illustrates one embodiment of method 2400 for analyzing a response. At 2405, a question from a person (e.g., a community member, a customer, and others) can be collected. At 2410, a request can be sent to a community to answer. Check 2415 can determine if the community answered. If the community responds, then the response can be analyzed at 2420. A check 2425 can determine if a response is sufficient (e.g., if the community provided enough answers to give credibility to the answer, if the response answered the question, and others). If the response is sufficient, then the response can be submitted to the person at 2430 and a database can be updated with the response at 2435. In one embodiment, updating the database includes adding a new entry, replacing an out-of-date entry, replacing an entry based on an idea that more information is known (e.g., more members of the community responded), give stronger credibility to an entry already in the database, and others. If check 2415 determines the community does not respond (e.g., in a pre-determined amount of time) or if check 2425 determines that the response is insufficient, then a database answer can be provided at 2440. If check 2415 determines the community does not respond (e.g., in a pre-determined amount of time) or if check 2425 determines that the response is insufficient, then logic on when to go to the community and/or when to go to the database can be trained.

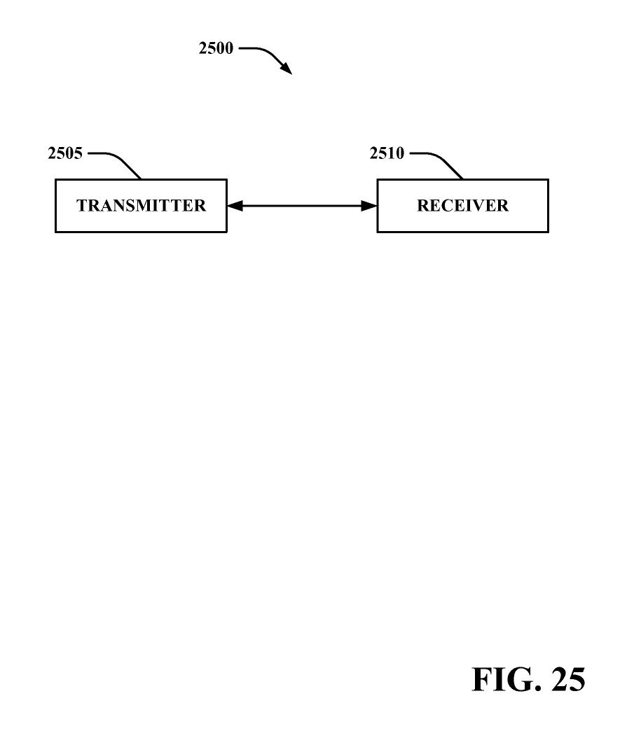

FIG. 25 illustrates one embodiment of a system 2500 that may be used in practicing at least one aspect disclosed herein. The system 2500 includes a transmitter 2505 and a receiver 2510. In one or more embodiments, the transmitter 2505 can include reception capabilities and/or the receiver 2510 can include transmission capabilities. In one embodiment, the system 100 of FIG. 1 includes the transmitter 2505 and/or the receiver 2510. In one example, the receiver 2510 integrates with and/or functions as the collection component 105 of FIG. 1 to obtain the vote 115 of FIG. 1. In one embodiment, the system 100 of FIG. 1 and/or the system 1200 of FIG. 12 integrate with the system 2500 on a mobile device.

The transmitter 2505 and receiver 2510 can each function as a client, a server, and others. The transmitter 2505 and receiver 2510 can each include a computer-readable medium used in operation. The computer-readable medium may include instructions that are executed by the transmitter 2505 or receiver 2510 to cause the transmitter 2505 or receiver to perform a method. The transmitter 2505 and receiver 2510 can engage in a communication with one another. This communication can over a communication medium. Example communication mediums include an intranet, an extranet, the Internet, a secured communication channel, an unsecure communication channel, radio airwaves, a hardwired channel, a wireless channel, and others. Example transmitters 2505 include a base station, a personal computer, a cellular telephone, a personal digital assistant, and others. Example receivers 2510 include a base station, a cellular telephone, personal computer, personal digital assistant, and others. The example system 2500 may function along a Local Access Network (LAN), Wide Area Network (WAN), and others. The aspects described are merely an example of network structures and intended to generally describe, rather than limit, network and/or remote applications of features described herein.

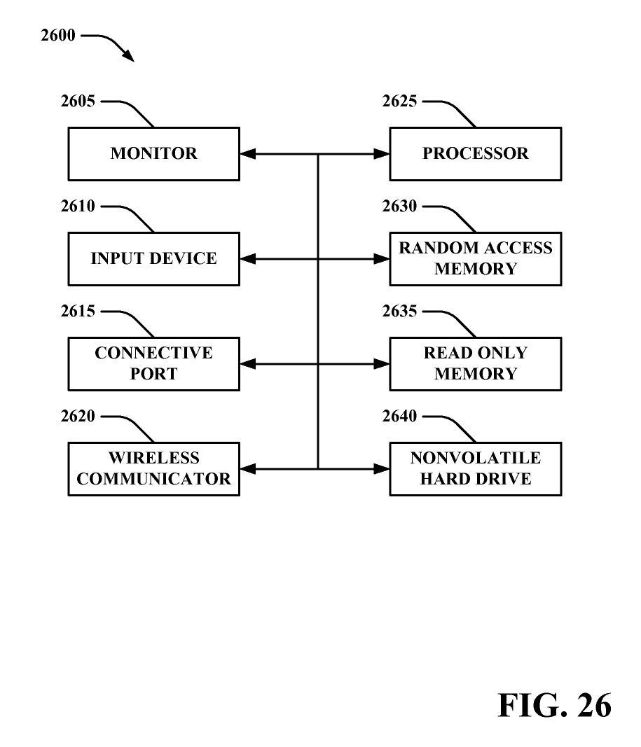

FIG. 26 illustrates one embodiment of a system 2600, upon which at least one aspect disclosed herein can be practiced. In one embodiment, the system 2600 can be considered a computer system that can function in a stand-alone manner as well as communicate with other devices (e.g., a central server, communicate with devices through data network (e.g., Internet) communication, etc). Information can be displayed through use of a monitor 2605 and a user can provide information through an input device 2610 (e.g., keyboard, mouse, touch screen, etc.). In one embodiment, the monitor 2605 displays the interface 600 of FIG. 6. A connective port 2615 can be used to engage the system 2600 with other entities, such as a universal bus port, telephone line, attachment for external hard drive, and the like. Additionally, a wireless communicator 2620 can be employed (e.g., that uses an antenna) to wirelessly engage the system 2600 with another device (e.g., in a secure manner with encryption, over open airwaves, and others). A processor 2625 can be used to execute applications and instructions that relate to the system 2600. In one example, the processor 2625 executes at least one instruction associated with at least one of the collection component 105 of FIG. 1 or the selection component 110 of FIG. 1. Storage can be used by the system 2600. The storage can be a form of a computer-readable medium. Example storage includes random access memory 2630, read only memory 2635, or nonvolatile hard drive 2640. In one embodiment, a memory (e.g., at least one of the random access memory 2630, read only memory 2635, and/or the nonvolatile hard drive 2640) retains instructions that cause a method disclosed herein to operate. In one embodiment, the memory retains a database in accordance with at least one aspect disclosed herein.

The system 2600 may run program modules. Program modules can include routines, programs, components, data structures, logic, etc., that perform particular tasks or implement particular abstract data types. The system 2600 can function as a single-processor or multiprocessor computer system, minicomputer, mainframe computer, laptop computer, desktop computer, hand-held computing devices, microprocessor-based or programmable consumer electronics, and the like.

It is to be appreciated that aspects disclosed herein can be practiced through use of artificial intelligence techniques. In one example, a determination or inference described herein can, in one embodiment, be made through use of a Bayesian model, Markov model, statistical projection, neural networks, classifiers (e.g., linear, non-linear, etc.), using provers to analyze logical relationships, rule-based systems, or other technique.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, innovative aspects are not limited to the specific details, the representative apparatus, and illustrative examples shown and described. Thus, this application is intended to embrace alterations, modifications, and variations that fall within the scope of the appended claims.

Functionality described as being performed by one entity (e.g., component, hardware item, and others) may be performed by other entities, and individual aspects can be performed by a plurality of entities simultaneously or otherwise. For example, functionality may be described as being performed by a processor. One skilled in the art will appreciate that this functionality can be performed by different processor types (e.g., a single-core processor, quad-core processor, etc.), different processor quantities (e.g., one processor, two processors, etc.), a processor with other entities (e.g., a processor and storage), a non-processor entity (e.g., mechanical device), and others.

In addition, unless otherwise stated, functionality described as a system may function as part of a method, an apparatus, a method executed by a computer-readable medium, and other embodiments may be implemented in other embodiments. In one example, functionality included in a system may also be part of a method, apparatus, and others.

Where possible, example items may be combined in at least some embodiments. In one example, example items include A, B, C, and others. Thus, possible combinations include A, AB, AC, ABC, AAACCCC, AB, ABCD, and others. Other combinations and permutations are considered in this way, to include a potentially endless number of items or duplicates thereof.

1-28. (canceled)

29. A non-transitory computer-readable medium storing processor executable instructions that when executed by a computer cause the computer to perform a method, the method comprising:
obtaining a first member choice from a first member selecting at least one service among one or more services offerable by an establishment;
obtaining at least a second member choice from at least second member selecting at least one service among the one or more services offerable by the establishment, services of the one or more services offerable by the establishment are classified into two or more categories;
aggregating the first member choice and at least the second member choice into a decision result identifying a highest gaining category among the two or more categories based on the decision result, the highest gaining category is identified by aggregating the first member choice and at least the second member choice for the one or more services offerable by the establishment according to the two or more categories,
wherein at least a third member choice is obtained from at least a third member if a tie is present among the two or more categories, wherein the third member choice is used to break the tie; and
proactively determining a service selection for at least one of the one or more services based, at least in part, on the highest gaining category of the decision result after the first member choice and at least the second member choice are aggregated into the decision result.

30. (canceled)

31. The non-transitory computer-readable medium of claim 29, where options for the one or more services offerable by the establishment are submitted by at least one of the first member or at least the second member.

32-39. (canceled)

40. A system, comprising:
a collection component configured to obtain a vote related to two or more products, the two or more products including a first product and a second product, the first product identified in a first category, and the second product identified in a second category different from the first category;
a weight component configured to apply a weight factor to the vote to produce a weighted vote, the weight factor is based on a membership of a voter who cast the vote;
a security component configured to determine the vote is not subject to tampering;
an aggregation component configured to aggregate the weighted vote into a vote result in response to determining the vote not being subject to tampering, the vote result indicating weighted totals for at least the first product, the second product, the first category, and the second category; and
a selection component configured to select a highest totaling product from the category with the higher total, wherein a system manager selects the highest totaling product in the event of a tie.

41. The system of claim 40, obtaining the vote is initiated based on a question submitted by the voter associated with the vote.

42. The system of claim 40, the membership includes one or more of a customer group, a product expert status, an employee status related to a business offering products within the first category or the second category, and a subscription purchasing group.

43. The system of claim 40, the weight factor is based at least in part on the voter spending a credit on the vote.

44. The system of claim 40, the weight factor is based at least in part on a voting history of the voter.

45. The system of claim 40, the weight factor is based at least in part on a purchase history of the voter.

46. The system of claim 40, further comprising an implementation component configured to proactively implement the selection by placement of an order of the selected product from the highest gaining category.

47. The system of claim 46, further comprising a monitor component configured to observe an effectiveness level of the implementation of the selected product based at least in part on a subsequent sale history of the selected product.

48. The system of claim 47, further comprising an update component configured to update a vote database including the vote based on the effectiveness level.

49. The system of claim 40, further comprising an amount component configured to determine a benefit to compensate for the vote.

50. The system of claim 49, the benefit is based at least in part on a voting member's membership to an organization, the organization includes one or more of a customer group, a product expert, and an employee of a business offering products within the first category or the second category.

51. The system of claim 40, wherein two or more category products within the first category or the second category are substitutes for one another.

52. The non-transitory computer-readable medium of claim 29, the method further comprising:
producing a vote security evaluation based at least in part on a source of at least one of the first member choice and at least the second member choice, at least one of the first member choice and the at least second member choice is not aggregated when having a failing vote security evaluation and at least one of the first member choice and at least the second member choice is aggregated when having a passing vote security evaluation.

53. The non-transitory computer-readable medium of claim 52, the vote security evaluation prevents tampering by failing at least one of the first member choice and at least the second member choice originating from a provider of any of the one or more services offerable by the establishment.

54. The non-transitory computer-readable medium of claim 52, the vote security evaluation detects an irregularity in a voting pattern using a comparison of the first member choice and at least the second member choice against the voting pattern, at least one of the first member choice and at least the second member choice is not aggregated based on the irregularity.

55. The non-transitory computer-readable medium of claim 52, the vote security evaluation verifies a demographic of the first member and at least the second member, at least one of the first member choice and at least the second member choice is aggregated or not aggregated based on the demographic.

56. The non-transitory computer-readable medium of claim 29, the method further comprising weighting at least one of the first member choice and at least the second member choice based on a membership of the first member and at least the second member.

57. A system, comprising:
means for obtaining a first member choice from a first member selecting at least one service among one or more services offerable by an establishment;
means for obtaining at least a second member choice from at least second member selecting at least one service among the one or more services offerable by the establishment, services of the one or more services offerable by the establishment are classified into two or more categories;
means for aggregating the first member choice and at least the second member choice into a decision result identifying a highest gaining category among the two or more categories based on the decision result, the highest gaining category is identified by aggregating the first member choice and at least the second member choice for the one or more services offerable by the establishment according to the two or more categories; and
means for proactively determining a service selection for at least one of the one or more services based, at least in part, on the highest gaining category of the decision result after the first member choice and at least the second member choice are aggregated into the decision result, wherein a tie for the highest gaining category is broken using artificial intelligence.
